(19) United States
(12) Patent Application Publication
(10) Pub. No.: US 2015/0247071 A1
(43) Pub. Date: Sep. 3, 2015

(54) Adhesive bonding by polymer chain reconfiguration

(71) Applicant: Robert Bosch GmbH, Stuttgart (DE)

(72) Inventors: Cyrille CAILLIE, Sonthofen (DE); Alfred GLATZ, Sonthofen (DE); Wilfried AICHELE, Winnenden (DE); Rainer HEINRICH HOERLEIN, Stuttgart (DE); Wolfgang-Michael MUELLER, Stuttgart (DE); Williamson SY, Schwaebisch Gmuend (DE)

(21) Appl. No.: 14/634,160

(22) Filed: Feb. 27, 2015

(30) Foreign Application Priority Data
Feb. 28, 2014 (DE) 10 2014 203 653.4

(51) Int. Cl. C09J 135/00; B32B 27/08; B32B 15/08; B32B 37/04; B32B 7/10

(52) U.S. Cl. CPC C09J 135/00; B32B 37/04; B32B 7/10; B32B 15/08; B32B 27/08

(57) ABSTRACT

A method is described for joining, in particular adhering, plastic to a substrate. To achieve a strong adhesive effect, in a method task a) a plastic material that encompasses at least one thermally reversibly cleavable polymer is furnished, and in a method task b) the plastic material is brought into contact with the substrate, a portion of the plastic material which is brought into contact with the substrate being heated to a temperature at which the at least one thermally reversibly cleavable polymer of the plastic material becomes thermally cleaved, and re-cooling or being re-cooled while in contact with the substrate. Also described is a plastic/substrate composite manufactured thereby, a polymer, and a polymer use for adhering.

### RELATED APPLICATION INFORMATION

The present application claims priority to and the benefit of German patent application no. 10 2014 203 653.4, which was filed in Germany on Feb. 28, 2014, the disclosure of which is incorporated herein by reference.

### FIELD OF THE INVENTION

The invention relates to a method for joining, in particular adhering, plastic to a substrate; to a plastic/substrate composite manufactured thereby; to a polymer; and to a polymer use for adhesive bonding.

### BACKGROUND INFORMATION

Merely injection-molding a thermoplastic material, for example a plastic, onto or over another material, for example a metal, is often insufficient to achieve a hermetically sealed interface between the two materials.

In particular, gaps can form at the interface between the two materials and can result in lack of sealing. This can occur in particular when the adhesion between the two materials is not strong enough to withstand forces that act, for example as a result of different coefficients of thermal expansion (CTE) in the two materials, in particular in the case of plastic and metal, and/or material deformation under large loads.

In order to achieve improved sealing, small structures, for example nanostructures, can be formed on the surface of a, for example, metallic substrate, which serve as physical anchoring points for the injection-molding material and can increase the adhesion area.

The small structures are conventionally formed by chemical etching or laser etching. This is very cost-intensive, however, and unsuitable for large areas.

It is also possible to apply onto the substrate an intermediate material onto which the injection-molding material is injected. The intermediate material is thermally softened in order to achieve sufficient adhesion between the intermediate material and the injection-molding material.

Thermal softening of the intermediate material can occur during the injection molding process. The temperature window in which the intermediate material softens sufficiently to achieve adhesion of the injection molded material, but does not soften too much and is not floated away by the injection-molding material, is nevertheless usually too narrow for mass production. In addition, the adhesion of the intermediate material to the substrate and/or to the injection-molding material is usually too weak to withstand large loads.

Thermal softening of the intermediate material can, however, also be accomplished by a thermal post-treatment. Intermediate materials suitable for this are, however, special materials, such as partly hardened epoxy adhesives, which for the most part are very cost-intensive. It is moreover problematic to establish, before injection molding with thermoplastics, a specific degree of pre-hardening which furthermore usually falls within a narrow range. Partly hardened coatings are moreover usually susceptible to damage during handling. In addition, for complete curing of the intermediate material, for example an adhesive, as a rule the entire article must be heated for a considerable time.

The documents GB 1431324 and U.S. Pat. No. 4,421,827 discuss composites of metal and thermosetting plastics.

### SUMMARY OF THE INVENTION

The subject matter of the present invention is a method for joining, in particular adhering, plastic to a substrate, encompassing the method tasks of:
a) furnishing a plastic material that encompasses at least one thermally reversibly cleavable polymer,
b) bringing the plastic material into contact with a substrate,
   a portion of the plastic material which is brought into contact with the substrate being heated to a temperature at which the at least one thermally reversibly cleavable polymer becomes thermally cleaved, and re-cooling or being re-cooled while in contact with the substrate.

Re-cooling can occur in particular both actively, for example by active cooling, and passively, for example by being left to cool.

Thermal cleavage of a polymer can encompass or be, for example, a thermal depolymerization and/or radicalization, and/or linking initiation or linking activation, in particular of the polymer. Thermal cleavage of a polymer can, for example, encompass or be a thermal depolymerization and/or radicalization, in particular of the polymer. For example, a thermal cleavage of a polymer can encompass or be a thermal depolymerization, in particular of the polymer.

A “thermally reversibly cleavable polymer” can be understood in particular as a polymer whose thermal cleavage, for example depolymerization and/or radicalization and/or linking initiation and/or linking activation, occurs reversibly, i.e. one which, once it has been cleaved at a specific temperature, which can also be referred to as a “cleavage temperature” and in particular can be appreciably above the melting point or softening temperature of the polymer, can (re-)polymerize upon cooling below that temperature.

As a result of the fact that the at least one thermally reversibly cleavable polymer is heated to a temperature at which it becomes cleaved, the thermally reversibly cleavable polymer can be cleaved into very small structural units, which can penetrate into very small pores or structures in the surface of the substrate and can reassemble into the thermally reversibly cleavable polymer upon cooling. This can occur in particular in a manner accompanied by a reconfiguration of the polymer chains, which can also be referred to as “polymer chain reconfiguration.”

The cleaved structural units occurring upon heating are advantageously appreciably smaller than softened or melted polymer chains can be, and can therefore also penetrate into smaller pores or structures in the surface of the substrate than softened and melted polymer chains can. Joining of the plastic to the substrate can in turn thereby advantageously be intensified or in some cases in fact be made possible in the first place.

In the context of an embodiment, the substrate is a metal substrate. For example, the substrate can encompass or can be constituted from at least one metallic material selected from the group consisting of steel, for example stainless steel, copper, aluminum, magnesium, and combinations or mixtures thereof. The metal substrate can be, for example, a tube or a sleeve or a plate.

Thermally reversibly cleavable polymers can advantageously be cleavable into, for example, radical and/or acidic and/or basic structural units that react with the surface of the substrate and, for example, can clean it or can remove a passivation layer from it. This has proven particularly advantageous in the context of metal substrates, made e.g. of steel, for example stainless steel, copper, aluminum, and magnesium, that conventionally have a passivated surface and must therefore usually be cleaned, for example by etching, before application of another material, for example an injection-molding material, and/or must be surface-treated, for example with a removing method, for example a grinding method.

In the context of an embodiment, the substrate is a plastic substrate. The plastic substrate can be, for example, a tube or a sleeve or a plate or a disk. If the substrate is a plastic substrate, structural units of the thermally reversibly cleavable plastic material can advantageously react with structural units of the plastic substrate and can form chemical, in particular covalent, bonds between the plastic material and the substrate. Advantageously, for example, strong plastic-substrate joins, which can be stronger than bonds based on adhesion, can be achieved. Advantageously, the materials of the plastic material and of the plastic substrate can be selected relatively freely. For example, a coordination of mutually chemically reactive functional groups can be dispensed with in terms of the materials. In order to strengthen the joins further, however, it is nevertheless possible to coordinate the materials with one another, in particular additionally, in terms of chemically reactive functional groups.

In the context of an embodiment, however, the plastic substrate (also) encompasses at least one thermally reversibly cleavable polymer.

Heating of the plastic material can occur in particular in a method task c).

For example, upon heating, in particular in method task c), a portion of the plastic substrate that is brought into or is in contact with the plastic material can also be heated. For example, that portion of the plastic substrate which is brought into or is in contact with the plastic material can be heated to a temperature at which the at least one thermally reversibly cleavable polymer of the plastic substrate becomes cleaved, and can re-cool or be re-cooled while in contact with the plastic material.

It is thus in fact advantageously possible for structural units of the thermally reversibly cleavable plastic material to exchange, during heating, with structural units of the thermally reversibly cleavable plastic substrate; this can also be referred to as “reflow polymer chain member exchange” or green space (block) copolymerization and/or graft reaction, and additionally are configured, for example, to yield intermolecular, chemical, in particular covalent, bonds between structural units of the thermally reversibly cleavable plastic material and structural units of the thermally reversibly cleavable plastic substrate, for example also intramolecular, chemical, in particular covalent, bonds between structural units of the thermally reversibly cleavable plastic material and structural units of the thermally reversibly cleavable plastic, to the plastic material and to the substrate.

Heating and re-cooling advantageously allows the achievement of particularly strong plastic-plastic joins, which can be appreciably stronger than bonds based on adhesion. Advantageously, the materials of the plastic material and of the plastic substrate can be selected relatively freely. Because reflow polymer chain member exchange can occur even without the coordination of mutually chemically reactive functional groups in the materials, this can advantageously also be dispensed with. In order to obtain particularly strong joins, however, it is nevertheless also possible to coordinate the materials with one another, in particular additionally, in terms of chemically reactive functional groups.

Conventional methods for joining plastics to substrates, for example metal substrates and plastic substrates, are carried out at temperatures that are not sufficiently high to bring about thermal cleavage, for example depolymerization and/or radicalization and/or linking initiation and/or linking activation, of polymers. In conventional injection molding, for example, the temperature of the injection mold must be below the melting point or softening temperature of the injection-molding material, and in particular appreciably below the cleavage temperature of the polymers present therein.

The invention is based on findings that were obtained in the context of adhesive bonding experiments between an injection-molded plastic and a metal substrate, in particular in the form of a metal plate. It was found in this context that at temperatures around the melting point or softening temperature, it was not possible to bring about sufficient adhesion between the plastic substrate and the metal substrate. Surprisingly, however, it was possible to achieve a very strong join as a result of treatment at a temperature above the cleavage temperature.

It has become apparent, for example, that materials that normally cannot adhere strongly to one another, such as polyamide to metal, e.g. polyamide 6.6 (PA66) to steel, or epoxy resin to polyamide, for example epoxy acrylic paint to polyamide 6.6 (PA66), or polyamide to polyester, for example polyamide 6.6 (PA66) to polybutylene terephthalate (PBT), can be caused to adhere strongly to one another by a thermal treatment above their cleavage temperature. For example, polyamide, e.g. polyamide 6.6 (PA66), can be caused to adhere strongly to metal, for example steel, or epoxy resin, for example epoxy acrylic paint, can be caused to adhere strongly to polyamide, for example polyamide 6.6 (PA66), or polyamide, for example polyamide 6.6 (PA66), can be caused to adhere directly to polyester, for example polybutylene terephthalate (PBT).

This can advantageously be accomplished in a wide processing temperature window. In the case of adhesion of polyamide 6.6 (PA66) to polybutylene terephthalate (PBT) or steel, for example, a processing temperature window of at least 100° C. can be achieved. Process requirements, in particular temperature control, for the method can thus be decreased, and a wide processing window that is, for example, insensitive to manufacturing tolerances can be achieved.

In the context of the method, the plastic and the substrate can advantageously be joined directly to one another. The substrate can advantageously be both a plastic substrate and a metal substrate.

For example, the plastic can be joined directly to the substrate by the fact that the plastic material, encompassing at least one thermally reversibly cleavable polymer, is placed onto the substrate, in particular directly, in the form of a shaped plastic part. Optionally, the plastic material can be pressed onto the substrate, or placement can be/accomplished under pressure.

In the context of an embodiment, the bringing of the plastic material into contact with the substrate, in particular in method task b), is therefore accomplished by, in particular direct, placement of the plastic material onto the substrate. The plastic material can be placed onto the substrate in particular in the form of a shaped plastic part, for example in the form of a plastic layer/plastic film, or of a sleeve, for example a plastic sleeve, or of a plastic-coated sheet, for example in the form of a sleeve, or of a plastic handle or of a plastic disk or of a plastic tube. The geometry of the shaped plastic part can advantageously be freely selected. In addition, the substrate can advantageously be both a plastic substrate and a metal substrate. The heating and re-cooling of the reversibly cleavable polymer thus advantageously allows a shaped plastic part, for example a plastic handle, to be fastened in particularly simple and economical fashion onto a metal substrate or also onto a plastic substrate. Advantageously, for example, direct attachment of a shaped polyester part onto a steel substrate can be achieved.

It is likewise possible, however, to join the plastic to the substrate by the fact that the plastic material, encompassing at least one thermally reversibly cleavable polymer, is applied directly onto the substrate.

In the context of a further embodiment, the bringing of the plastic material into contact with the substrate, in particular in method task b), is therefore accomplished by, in particular direct, application of the plastic material onto the substrate.

In the context of an embodiment, the bringing of the plastic material into contact with the substrate, in particular in method task b), is accomplished by, in particular direct, application of the plastic material onto the substrate by injection molding. The plastic material can be, in particular, an injection-molding material. The geometry of the shaped injection-molded part constituted from the plastic material can advantageously be subject to few or no restrictions. In addition, the substrate can advantageously be both a plastic substrate and a metal substrate. The heating and re-cooling of the reversibly cleavable polymer thus advantageously allows a shaped injection-molded part, for example a plastic handle, to be fastened in particularly simple and economical fashion onto a metal substrate or also onto a plastic substrate. Advantageously, for example, direct attachment of a shaped polyamide part onto a steel substrate can be achieved.

In the context of another embodiment, the bringing of the plastic material with the substrate, in particular in method task b), is accomplished by, in particular direct, coating of the substrate with the plastic material. Here as well the substrate can advantageously be both a plastic substrate and a metal substrate. The heating and re-cooling of the reversibly cleavable polymer thus advantageously allows a plastic coating to be configured in particularly simple and economical fashion on a metal substrate or also on a plastic substrate.

Although many plastic materials, and in particular injection-molding materials, are suitable for adhering directly onto the substrate in the context of this method, and the method therefore allows a plastic, for example in the form of a shaped plastic part or a shaped injection-molded part or a plastic coating, to be joined directly to the substrate, it can be advantageous to use the plastic material, which in particular is to be brought into contact with the substrate and in particular encompasses the at least one thermally reversibly cleavable polymer, as an intermediate material for, in particular indirect, attachment of a further material, for example a metal or plastic, for example a metal object or a plastic object or a further plastic material, for example an injection-molding material. The further plastic material (explained in further detail below) both can itself represent the further material to be attached and optionally can itself serve as a further intermediate material. For example, the substrate can be joined to an injection-molding material and/or adhesively bonded to an object, for example a metal object or plastic object, via the plastic material serving as an intermediate material, for example in the form of an intermediate layer, and optionally via the further plastic material serving as a further intermediate material, for example in the form of a further intermediate layer.

The plastic material or further plastic material serving as an intermediate material can advantageously be optimized with regard to a maximization of adhesion or even chemical bonding to the substrate or further material, for example the injected-molded material or object, with no need in that context to adapt the properties of the further material, for example the injection-molding material or object.

For example, by way of a plastic material serving as an intermediate material and optionally a further plastic material serving as a further intermediate material, the surface of the substrate or of an object to be equipped therewith can be brought into and/or kept in a bondable and/or conductive state. For example, a substrate or object of this kind can be brought into and/or kept in a state that is free of a passivation layer, for example a corrosion-free state as in the case of stainless steel. A plastic material serving as an intermediate layer or the further plastic material serving as a further intermediate layer can advantageously additionally serve as a protective layer, for example in order to protect the surface of the substrate or of the object from passivation between being brought into contact with the substrate or object and being brought into contact with further material, for example plastic material, e.g. injection-molding material, and/or an object, for example during transport and/or storage.

It is thus possible all in all by way of the method to achieve, advantageously, a good adhesive effect or adhesion between plastic and substrate, for example directly between the plastic material and the substrate, and optionally, for example indirectly, via the plastic material and optionally the further plastic material, between the substrate and a further material, for example an injection-molding material or object. In particular, a good adhesive effect or adhesion can thereby advantageously also be achieved between different materials, for example of the substrate and of an object.

The adhesion or adhesive effect achievable can optionally in fact be so good that cost-intensive formation of anchoring structures, for example nanostructures, can be dispensed with.

The method can be used particularly advantageously in injection-molding applications, for example in order to achieve good adhesion between a metal substrate and a plastic injection-molding material. The adhesion can be implemented both directly between an injection-molding material and a metal substrate, or optionally indirectly, for example by way of a plastic material, serving as an intermediate layer, which adheres on the one hand to the metal substrate and on the other hand to the injection-molding material.

Seals having an excellent sealing effect can thus in turn advantageously be obtained. In particular, hermetically sealed adhesion between metal substrates and injection-molding materials can thus also advantageously be obtained. For example, hermetically sealed overmolding of metal parts, for example with thermoplastics, can thereby be achieved, in particular in economical fashion.

In the context of further embodiments the plastic material, which in particular encompasses at least one thermally reversibly cleavable polymer, therefore serves as an intermediate material. For example, the plastic material serving as intermediate material can be applied, for example in method task b) or in a method task y) explained later, in the form of a shaped plastic part, for example in the form of a plastic layer/plastic film, or of a sleeve, for example a plastic sleeve, or of a plastic-coated sheet, for example in the form of a sleeve, or of a plastic handle or a plastic disk or a plastic tube, or a plastic coating, onto the substrate, in particular in method task b), or onto the further material, in particular in method task y). The layer or coating constituted from the plastic material can in particular serve as an intermediate layer and can be referred to as such. Economical application of an intermediate material onto a substrate, for example a metal substrate or plastic substrate, can therefore also be made available by the embodiments described above for bringing the plastic material into contact, for example by coating, placement, and/or injection molding.

In the context of a further embodiment, in particular in which the plastic material serves as an intermediate material, a further plastic material is applied onto the plastic material. In particular in method task c), a portion of the plastic material that is brought into or is in contact with the further plastic material, can in particular be heated to a temperature at which the at least one thermally reversibly cleavable polymer of the plastic material becomes cleaved, and can re-cool or be re-cooled while in contact with the further plastic material. The further plastic material can advantageously be joined to the plastic material, for example via a crosslinking reaction and/or grafting reaction, by the heating and re-cooling of the reversibly cleavable polymer of the plastic material. A portion of the further plastic material which is brought into or is in contact with the plastic material can optionally also be heated. The first plastic material can optionally be a plastic material that does not encompass a thermally reversibly cleavable polymer.

In the context of an embodiment, however, the further plastic material also encompasses at least one thermally reversibly cleavable polymer or is constituted therefrom. In particular in method task c), for example, a portion of the further plastic material which is is brought into or is in contact with the plastic material can, for example, also be heated to a temperature at which the at least one thermally reversibly cleavable polymer of the further plastic material becomes cleaved, and can re-cool or be re-cooled while in contact with the plastic material.

A reflow polymer chain member exchange or green space (block) copolymerization reaction and/or grafting reaction can thus advantageously be brought about between the thermally reversibly cleavable polymers of the plastic material and of the further plastic material, and particularly strong plastic/plastic joins, which can be appreciably stronger than bonds based on adhesion, can advantageously be achieved. Here as well, advantageously, the materials of the plastic material and of the further plastic material can be selected relatively freely. Because reflow polymer chain member exchange can occur even without coordination of mutually chemically reactive functional groups in the materials, such coordination can advantageously also be omitted. In order to strengthen the joins further, however, it is also possible here to coordinate the materials with one another, in particular additionally, with regard to mutually chemically reactive functional groups.

In the context of an embodiment, application of the further plastic material onto the plastic material is accomplished by, in particular direct, placement of the further plastic material onto the plastic material. The further plastic material can be constituted in particular in the form of a shaped plastic part, for example in the form of a plastic layer/plastic film or of a sleeve, for example a plastic sleeve, or of a plastic-coated sheet, for example in the form of a sleeve, or of a plastic handle or a plastic disk or a plastic tube.

In the context of another embodiment, application of the further plastic material onto the plastic material is accomplished by, in particular direct, application of the further plastic material onto the plastic material.

For example, application of the further plastic material onto the plastic material can be accomplished by, in particular direct, application of the plastic material onto the plastic material by injection molding. The further plastic material can in particular be an injection-molding material.

Application of the further plastic material onto the plastic material can also, however, be accomplished, for example, by, in particular direct, coating of the plastic material with the further plastic material.

The further plastic material can optionally also, for example for joining a metal substrate to a metal object, serve as a further intermediate material. The further plastic material serving as a further intermediate material can encompass, for example, at least one thermally reversibly cleavable polymer. A layer or coating configured from the further plastic material can serve in particular as a further intermediate layer and can be referred to as such. Economical application of a further intermediate material can thus also be advantageously made available by way of the above-described embodiments for applying the further plastic material, for example by coating, placement, and/or injection molding.

The furnishing or application of the further plastic material onto the plastic material can be carried out in particular in a method task x).

The method task x) can be carried out, for example, before method task b).

For example, the further plastic material can be applied onto the plastic material before the plastic material is brought into contact with the substrate, in particular in method task b). For example, method task x) can be carried out before method task a) or in the course of method task a). In method task a), for example, a plastic material can be furnished which encompasses at least one reversibly cleavable polymer and on which at least one further plastic material is applied.

For example, in method task a) a shaped plastic part, for example in the form of a plastic layer/plastic film or of a sleeve, e.g. a plastic sleeve, or of a plastic-coated sheet, e.g. in the form of a sleeve, or of a plastic handle or plastic disk or plastic tube, which is constituted locally from the further plastic material, can be furnished. For example, in method task a) a shaped part, for example a plastic layer/plastic film, can be furnished, in which one surface, for example a lateral surface, is constituted in portions from the plastic material which encompasses at least one reversibly cleavable polymer, and in portions from the further plastic material.

Alternatively thereto, method task x) can also be carried out after method task a), and in particular before method task b).

In the context of a further alternative, however, method task x) can also be carried out after method task b). For example, the further plastic material can be applied after the plastic material is brought into contact with the substrate, in particular in method task b).

Method task x) can be accomplished before heating and/or during heating and/or after heating of the at least one thermally reversibly cleavable polymer, in particular in method task c). Method task x) can be carried out, for example, before or in the course of method task a), or after method task a) and in particular before method task b), or in the course of or after method task b), and in particular before, in the course of, or after heating, for example in method task c).

In the context of a further embodiment, in method task a) the plastic material or the at least one thermally reversibly cleavable polymer of the plastic material is furnished in completely solidified form, or the plastic material or the at least one thermally reversibly cleavable polymer of the plastic material is completely solidified, in particular in a method task b1). For example, the plastic material can in this context be fully polymerized or cured. In particular, method task b1) can be carried out before heating, in particular in method task c). Method task b1) can optionally be carried out before heating, in particular in method task c) and before application of a further material, for example in method task x) and/or optionally y). Completely solidified or cured materials can advantageously be more easily handled. The handling of the plastic material can thus advantageously be appreciably simplified, for example as compared with liquid or pasty plastic materials. In addition, it is thereby possible advantageously to prevent the plastic material, for example a coating thereof, from being washed away by the further plastic material during injection molding. The further plastic material or the at least one thermally reversibly cleavable polymer of the further plastic material can optionally also be furnished in completely solidified form, or the further plastic material or the at least one thermally reversibly cleavable polymer of the further plastic material can be completely solidified, for example, after method task x) and optional before method task c).

In the context of several embodiments, in particular in which the plastic material serves as an intermediate material, the substrate is joined to an object via the plastic material encompassing at least one thermally reversibly cleavable polymer. Joining can be accomplished both (directly) via the plastic material encompassing at least one thermally reversibly cleavable polymer, or optionally additionally via the further plastic material, for example encompassing at least one thermally reversibly cleavable polymer.

Good adhesive strength between two materials, in particular the substrate and the object, can advantageously be achieved by way of the plastic material and optionally the further plastic material. Adhesive bonding of different material combinations can, for example, advantageously be enabled.

In the context of an embodiment, the object is a metal object. For example, the object can be a metal object that encompasses or is constituted from at least one metallic material selected from the group consisting of steel, for example stainless steel, copper, aluminum, and/or magnesium and combinations or mixtures thereof. For example, the metal object can be a tube or a sleeve or a plate. If the substrate is a metal substrate, the metal substrate and the metal object can be constituted from identical or different metallic materials.

The metal object can optionally be equipped, for example coated, with the further plastic material, in particular with the further plastic material encompassing at least one thermally reversibly cleavable polymer. The metal object can, however, also be a metal object as such, or can be free of the further plastic material.

In the context of another embodiment, the object is a plastic object. For example, the plastic object can be a tube or a sleeve or a plate or disk. If the substrate is a plastic substrate, the plastic substrate and the plastic object can be constituted from identical or different plastics.

The plastic object can optionally be constituted from a plastic material that does not encompass a thermally reversibly cleavable polymer. For example, the plastic object can be constituted from carbon-fiber-reinforced plastic (CFRP). For example, the plastic object can be a plastic tube, made for example of carbon-fiber-reinforced plastic (CFRP).

In the context of a special embodiment, however, the plastic object also encompasses at least one thermally reversibly cleavable polymer.

The plastic object can be constituted, for example, from a plastic that encompasses at least one thermally reversibly cleavable polymer. For example, the plastic object can be constituted from the further plastic material, in particular encompassing at least one thermally reversibly cleavable polymer. The plastic object can optionally be a shaped plastic part, for example made of the further plastic material encompassing at least one thermally reversibly cleavable polymer, in particular in accordance with method task x), such that, for example, method task y) can then correspond to method task x).

The plastic object can optionally be equipped or provided with the further plastic material, in particular with the further plastic material encompassing at least one thermally reversibly cleavable polymer. For example, the plastic body can be coated with the further plastic material, in particular with the further plastic material encompassing at least one thermally reversibly cleavable polymer. The plastic object (itself) can, for example, also be free of the further plastic material.

In the context of one of these embodiments, the method furthermore encompasses method task y): bringing the plastic material or the further plastic material into contact with an object, for example a metal object or plastic object. For example, the object can be applied onto the plastic material or onto the further plastic material, or can be placed onto the plastic material or onto the further plastic material.

Alternatively or additionally, in method task y) the plastic material can be brought into contact with an object, for example a metal object or plastic object, that is provided, for example coated, with the further plastic material, in particular encompassing at least one thermally reversibly cleavable polymer. The object, for example the metal object or plastic object, can in particular be brought into contact with the plastic material, or placed onto the plastic material, in such a way that the plastic material and the further plastic material contact one another.

Alternatively thereto, however, the object, for example the metal object or plastic object, can also be free of the further plastic material.

In this context, for example, in particular in method task c), a portion of the plastic material and/or of the further plastic material which is brought into or is in contact with the object can also be heated to a temperature at which the at least one thermally reversibly cleavable polymer of the plastic material and/or of the further plastic material becomes cleaved, and can re-cool or be re-cooled while in contact with the object. In particular, a portion of the object which is brought into or is in contact with the plastic material and/or with the further plastic material can also be heated. The body can advantageously thereby be joined to the plastic material or to the further plastic material by the heating and re-cooling of the reversibly cleavable polymer of the plastic material or of the further plastic material.

In the context of a special embodiment, the object is a plastic object that is provided, for example coated, with the further plastic material, in particular with the further plastic material encompassing the at least one thermally reversibly cleavable polymer. The plastic object can in particular be brought into contact with the plastic material, or placed onto the plastic material, in such a way that the plastic material and the plastic object, or the further plastic material of the plastic object, contact one another.

The plastic object can also optionally be a shaped plastic object, in particular in accordance with method task x), for example such that method task y) can then correspond to method task x). For example, however, the plastic object can also be free of the further plastic material.

The plastic object can in particular be brought into contact with the plastic material, or placed onto the plastic material, in such a way that the plastic material and the plastic object, or the further plastic material of the plastic object, contact one another.

In this context, for example, in particular in method task c), a portion of the plastic object and/or a portion of the further plastic material, which is brought into or is in contact with the object, can also be heated to a temperature at which the at least one thermally reversibly cleavable polymer of the plastic object and/or of the further plastic material becomes cleaved, and can re-cool or be re-cooled while in contact with the plastic material or with the further plastic material. A reflow polymer chain member exchange or green space (block) copolymerization reaction and/or grafting reaction can thus advantageously be brought about between the thermally reversibly cleavable polymers of the plastic object and of the plastic material and/or of the further plastic material, and particularly strong plastic/plastic joins, which can be appreciably stronger than bonds based on adhesion, can advantageously be achieved. Here as well, advantageously, the materials can be selected relatively freely. Advantageously, here as well the materials can be selected relatively freely and do not need to be coordinated with one another in terms of chemically reactive functional groups. In order to strengthen the joins further, however, it is also possible here to coordinate the materials with one another, in particular additionally, with regard to mutually chemically reactive functional groups.

By way of the plastic material and optionally the further plastic material, adhesive bonding of different plastics, for examples otherwise poorly adhesively bonded ones, can advantageously be brought about. A use of the plastic material in combination with the further plastic material advantageously makes it possible to coordinate the materials with their respective partners and thus to achieve particularly stable adhesive joining of different materials, such as different metals or different plastics, or of metal and plastic. In particular, the plastic material can be applied onto the one partner, for example plastic or metal, for example the plastic substrate or the metal substrate, and the further plastic material can be applied onto the other partner, for example plastic or metal, for example the plastic object or metal object.

Method task y) can be carried out, for example, after method task a) and optionally after method task b1) and optionally after method task x).

By way of the plastic material and optionally the further plastic material it is advantageously possible to bring about adhesive bonding of different metals, for example steel and aluminum or copper and magnesium, or of aluminum and carbon-fiber-reinforced plastic or magnesium, which are poorly bondable with conventional adhesive techniques, for example because their surfaces are difficult to bring into a good, for example oxide-free, state, or are difficult to keep in that state over a long period of time. With the plastic material and optionally the further plastic material, on the other hand, for example in the form of a paint coating, surfaces advantageously can be kept clean, for example oxide-free, without particular storage complexity, and optionally can in fact be brought into a clean, for example oxide-free, state.

Use of the plastic material in combination with the further plastic material advantageously makes it possible to coordinate the materials with their respective partners, for example substrate and object and optionally further substrate, and thereby to achieve particularly stable adhesive joining of different materials. For example, the plastic material and the further plastic material can be coordinated with different metallic partners, and particularly stable adhesive joining of different metals can thereby be achieved. For example, the plastic material can be applied onto the one metal and the further plastic material onto the other metal, The metals can thus be advantageously protected, by the plastic materials, from corrosion prior to thermal adhesive bonding.

In the context of another of these embodiments, in method task a) the plastic material encompassing at least one thermally reversibly cleavable polymer is furnished in a form applied on an object. In particular, the object can be plastic-material-equipped, in particular plastic-material-coated, on at least two sides. For example, the object can be provided, for example coated, with the plastic material, in particular encompassing at least one thermally reversibly cleavable polymer. The object can optionally be provided, for example coated (at least on one side), with the plastic material, in particular encompassing at least one thermally reversibly cleavable polymer, and provided, for example coated (at least on one side), with the further plastic material, in particular encompassing at least one thermally reversibly cleavable polymer. In method task b) at least one plastic-material-equipped side of the object can be brought into contact with the substrate, and at least one, for example another, plastic-material-equipped side of the object can be brought into contact with a further substrate. The plastic-material-equipped sides of the object which are brought into contact with the substrates can be heated, in particular in method task c), to a temperature at which the at least one thermally reversibly cleavable polymer of the plastic material and/or optionally of the further plastic material becomes thermally cleaved, and can re-cool or be re-cooled while in contact with the substrates.

In the context of a special embodiment at least two tubes are joined to one another, for example directly or indirectly, in particular by the method. Tube joins, for example of metal tubes, for example of a steel tube to an aluminum tube, or plastic tubes, or a metal tube and a plastic tube, can thereby advantageously be effected in simple fashion.

The tubes can be configured from different materials, for example from different metals such as aluminum and magnesium, or from different plastics, or one from metal, for example aluminum, and the other from plastic, for example carbon-fiber-reinforced plastic. In particular, the tubes can be metal tubes.

In particular, one of the tubes can be partly introduced into the other tube, for example slid in or slid on. One of the tube can therefore be referred to as an “inner tube” and the other tube as an “outer tube.”

The overlapping region between the tubes can in particular be equipped at least partly with the plastic material, in particular encompassing at least one thermally reversibly cleavable polymer, and optionally with the further plastic material, in particular encompassing at least one thermally reversibly cleavable polymer. For example, the overlapping region between the tubes can be equipped with the plastic material and optionally with the further plastic material in the form of an internal coating and/or external coating and/or of a shaped part, for example a sleeve and/or a plastic-material-coated sheet or a film.

In the context of an embodiment, the substrate and the further substrate are tubes. The object can be, for example, a sheet coated on both sides with plastic material, for example a steel sheet, for example in the form of a sleeve. The sheet coated on both sides with plastic material can be disposed between the tubes. The sheet can be coated at least with the plastic material, in particular encompassing at least one thermally reversibly cleavable polymer.

Optionally, the sheet can be coated (at least on one side) with the plastic material, in particular encompassing at least one thermally reversibly cleavable polymer, and (at least on one side) with the further plastic material, in particular encompassing at least one thermally reversibly cleavable polymer. For example, the sheet can be coated with the plastic material and optionally with the further plastic material in the form of a paint.

Advantageously, as a result of the coating of the sheet on both sides with the plastic material, not only joining but also insulation is achieved, and in that manner, for example, galvanic corrosion is prevented.

In addition, the sheet advantageously makes possible heating, for example by low-frequency heating. The sheet can be heated, in particular in method task c), to a temperature at which the at least one thermally reversibly cleavable polymer of the plastic material and optionally of the further plastic material becomes thermally cleaved, and can re-cool or be re-cooled while in contact with the substrates. The heating, in particular in method task c), can advantageously be accomplished by the fact that, for example only, the sheet is, in particular selectively, heated. The tubes, in particular the outer tube, can remain unheated. This can be achieved, for example, by low-frequency heating, e.g. at approximately 50 Hz, for example by inductive low-frequency heating, or by the application of an eddy current. The outer tube can advantageously serve as a kind of cage that limits the expansion of the sheet, which can be advantageous in particular with material combinations in which the material of the outer tube, for example aluminum, has a higher coefficient of thermal expansion than the sheet, for example steel, and or the inner tube. A sheet coated with plastic on both sides moreover can be manufactured in simple fashion and allows a possibly more complex internal coating to be omitted.

In the context of another embodiment, the substrate is a first tube and the object is a second tube. For example, the substrate can be configured in the form of a first metal tube and the object in the form of a second metal tube.

In this context in particular, a side of the first tube which faces toward the second tube can be equipped, in particular coated, with the plastic material encompassing at least one thermally reversibly cleavable polymer. Optionally, a side of the second tube which faces toward the first tube can be equipped, for example coated, at least partly with the further plastic material, in particular encompassing at least one thermally reversibly cleavable polymer. It is thereby once again advantageously possible to achieve not only joining but also insulation, and in that manner, for example, to prevent galvanic corrosion.

The first tube can be, for example, the inner tube, and the second tube can be the outer tube. It is likewise possible, however, for the first tube to be the outer tube and the second tube to be the inner tube.

For example, the outer side of the first, in particular inner, tube, for example of the substrate, can be or become equipped, for example coated, with the plastic material encompassing at least one thermally reversibly cleavable polymer. The inner side of the second, in particular outer, tube, for example of the object, can be or become equipped, for example coated, with the further plastic material. Or conversely the outer side of the second, in particular inner, tube, for example of the object, can be or become equipped, for example coated, with the plastic material encompassing at least one thermally reversibly cleavable polymer. The inner side of the first, in particular outer, tube, for example of the substrate, can be or become equipped, for example coated, with the further plastic material. In particular, the further plastic material can also encompass at least one thermally reversibly cleavable polymer.

Alternatively thereto, a shaped plastic part, for example in the form of a sleeve, or a plastic film, which part or film encompasses or is constituted from the plastic material encompassing at least one thermally reversibly cleavable polymer and optionally the further plastic material encompassing at least one thermally reversibly cleavable polymer, can be disposed between the inner tube and the outer tube. This also advantageously makes it possible to achieve not only joining but also insulation, and in that manner, for example, to prevent galvanic corrosion. In addition, a shaped plastic part, for example a plastic sleeve or a plastic film, can easily be manufactured and allows a possibly more complex internal coating to be omitted.

In the context of a further embodiment, the action of bringing into contact is accomplished, in particular in method task b), by way of a deformation method. In particular, at least one of the tubes can be deformed. For example, the outer tube can be shrunk onto the inner tube and/or the inner tube can be expanded, for example inflated, against the outer tube. The plastic material and the further plastic material, as well as optionally the sheet, can advantageously be brought into contact with one of the tubes or with both tubes, and can optionally be pressed between the tubes, for example under pressure.

Deformation can be implemented using a variety of deformation methods. For example, deformation can be accomplished by hydroforming and/or by way of a magnetic pulse method and/or by way of a mechanical deformation method.

Alternatively or additionally, for example, the inner tube can be explained or inflated by hydroforming. The outer tube can also be shrunk onto the inner tube by hydroforming.

Deformation can, however, also, for example, be accomplished by way of a magnetic pulse method, for example magnetic shaping (also called electromagnetic pulse technology, EMPT). The result can be that the inner tube becomes expanded or inflated, and/or the outer tube becomes shrunk.

Deformation can also be accomplished mechanically, for example by hammering, forging, etcetera. For example, the outer tube can be forged onto the inner tube.

The non-overlapped region or regions of the tubes or the undeformed region of the inner tube and/or of the outer tube can advantageously be used for a, for example analogous, join to a further component, for example to a further tube. Vehicle frames, for example for motor vehicles and/or bicycles, can thus advantageously be manufactured in simple fashion.

The inner tube can, in particular, have an outer radius that is smaller than the inner radius of the outer tube. In particular, the radial distance between the outer radius of the inner tube and the inner radius of the outer tube can be greater than or equal to the radial thickness of the plastic material or the sum of the radial thickness of the plastic material and/or the radial thickness of the further plastic material and/or the radial thickness of the sheet. If the radial distance between the outer radius of the inner tube and the inner radius of the outer tube is greater than the radial thickness of the plastic material or the sum of the radial thickness of the plastic material and/or the radial thickness of the further plastic material and/or the radial thickness of the sheet, the action of bringing into contact, in particular in method task b) can be accomplished, for example, using a deformation method.

If the first tube is the inner tube and the second tube the outer tube, the first tube can have an outer radius that is smaller than the inner radius of the second tube. In particular, the outer radius of the first tube can be smaller than the inner radius of the second tube by a magnitude that is greater than or equal to the radial thickness of the plastic material or the sum of the radial thickness of the plastic material and/or the radial thickness of the further plastic material.

If the second tube is the inner tube and the first tube the outer tube, the second tube can have an outer radius that is smaller than the inner radius of the first tube. In particular, the outer radius of the second tube can be smaller than the inner radius of the first tube by a magnitude that is greater than or equal to the radial thickness of the plastic material or the sum of the radial thickness of the plastic material and/or the radial thickness of the further plastic material.

If the radial distance between the outer radius of the first, inner tube and the inner radius of the second, outer tube, or between the outer radius of the second, inner tube and the inner radius of the first, outer tube, is greater than the radial thickness of the plastic material or the sum of the radial thickness of the plastic material and/or the radial thickness of the further plastic material, the action of bringing into contact, in particular in method task b), can be accomplished, for example, using a deformation method.

In the context of a further embodiment, in particular in which the plastic material serves as an intermediate material, an intermediate layer segment constituted from the plastic material is applied, in particular in method task b), onto the substrate. In particular, a plurality of intermediate layer segments constituted from the plastic material can be applied onto the substrate.

For example, in method task b) the substrate can be brought into contact with an intermediate layer, constituted from the plastic material, which is a structured, for example discontinuous or interrupted, layer, made up for example of optionally isolated intermediate layer segments or anchoring structures. The intermediate layer can be applied onto the substrate, for example, in the form of a coating or a shaped plastic part, for example a plastic layer/plastic film.

The further plastic material can be applied, in particular in method task x), onto an intermediate layer of this kind by injection molding. For example, an intermediate layer of this kind can be partly overmolded, in particular in method task x), with the further plastic material, In particular, the further plastic material can be molded onto the substrate in addition to the intermediate layer segments and, for example, in a manner surrounding the intermediate layer segments. In particular, an intermediate layer of this kind can become completely solidified or can be used in completely solidified form, in particular in method task b1) that can be carried out, for example, before method task x).

Advantageously, it is also possible to use a shaped plastic part that has an intermediate layer of this kind constituted from the plastic material, in particular having optionally isolated intermediate layer segments or anchoring structures, the intermediate layer segments or anchoring structures of which are partly overmolded with the further plastic material. Exposed or unovermolded surfaces of the intermediate layer segments or anchoring structures, and sub-segments of the further plastic material that partly surround the intermediate layer segments or anchoring structures, can together form an, in particular smooth, outer surface of the shaped plastic part. The smooth surface can be both a flat surface and a curved surface. In particular, the intermediate layer can also become or be completely solidified. Method task b) can, for example, be carried out after method task b1) and/or x).

Thanks to an intermediate layer of this kind, heating can advantageously cause the formation of chemical anchoring joins between the intermediate layer segments and the substrate and between the intermediate layer segments and the segments, adjacent thereto, of the injection-molded further plastic material (injection-molded segments), the result being that good attachment of the injection-molded further plastic material to the substrate can be achieved.

In the context of a special embodiment, application of the plastic material and/or of the further plastic material, in particular of the further plastic material, for example in method task b) and/or x), in particular x), is accomplished by injection molding.

Application can be accomplished in particular by way of an injection method and/or molding method. For example, in method task x) the plastic material can be over-injected and/or overmolded with the further plastic material. The further plastic material can serve, for example, as an injection-molding material, for example an over-injected and/or overmolded material. The plastic material can serve in particular as an intermediate material and can be, for example, pre-applied onto the substrate. The substrate can be, for example, a metal substrate.

For example, the substrate can (previously), in particular in method task b), be coated with the plastic material. The plastic material may be completely solidified, in particular in method task b1), before injection molding of the further plastic material, in particular in method task x). Method task x) can occur in particular after method tasks b) and b1).

After method task x), in particular in method task c), that portion of the plastic material which is brought into or is in contact with the substrate, and a portion of the plastic material which is brought into or is in contact with the further plastic material, for example an injection-molding material, can then be heated to a temperature at which the at least one thermally reversibly cleavable polymer of the plastic material, for example of the intermediate material, becomes cleaved.

The plastic material pre-applied onto the substrate, for example in the form of a coating on the substrate, can, for example, be overmolded with the further plastic material and thermally treated in such a way that the temperature of the interfaces between the different layers of the layer system—substrate, plastic material (intermediate material), and further plastic material (injection-molding material)—in particular the temperature of the interfaces of the plastic material (intermediate material) with the substrate and with the further plastic material (injection-molding material), is sufficiently high that the thermally reversibly cleavable polymer of the plastic material (intermediate material) becomes cleaved. At the interfaces of the plastic material (intermediate material), the temperature can in particular be higher than the melting point or softening point of the further plastic material (injection-molding material). The bulk of the further plastic material (injection-molding material) can, however, remain in particular below its melting point or softening point. This can be achieved, for example, by way of the heating methods explained later.

All in all it is thereby advantageously possible to achieve not only, for example in the case of a metal substrate, an adhesive bond between the plastic material (intermediate material) and the substrate, but also in particular a strong chemical, for example covalent, bond between the, for example coating-like, plastic material (intermediate material) and the further, for example thermoplastic, plastic material (injection-molding material). In the case of a plastic substrate, a strong chemical, for example covalent, bond between the, for example coating-like, plastic material (intermediate material) and the material of the plastic substrate can additionally be achieved.

For example, the substrate can be embodied in the form of a sleeve, for example a metallic sleeve, which becomes or is coated, for example painted, with the plastic material (intermediate material). The coating-like plastic material (intermediate material) can then be overmolded with the further plastic material (injection-molding material). After coating and/or overmolding, the materials can adhere only weakly to one another or can not yet form a chemical anchoring bond. As a result of heating, in particular of the interfaces of the plastic material (intermediate material), for example to a temperature of approximately 400° C., stable attachment of the materials to one another, and in particular a chemical anchoring bond, can then be achieved. For example, the plastic material (intermediate material) and the further plastic material (injection-molding material) can encompass polyamide.

The method advantageously requires a thermal activation of the adhesive-bonding or adhesion mechanism between the various layers, such as the substrate and plastic material, and optionally of the plastic material with the further plastic material and/or optionally with the object. Handling or processing management can thereby advantageously be simplified.

The portion of the plastic material or of the further plastic material or of the substrate or of the object can, as already explained, be heated to a temperature at which the at least one thermally reversibly cleavable polymer becomes thermally cleaved, for example depolymerized and/or radicalized and/or linking initiated and/or linking activated, in particular depolymerized and/or radicalized. This can be accomplished in particular by way of a thermal treatment or a thermal post-treatment. During this, in particular at least one functional group can be produced from the polymer chain of the at least thermally reversibly cleavable polymer, which can clean the surface of the substrate and/or form a chemical bond with the substrate and/or, for example if the plastic material serves as an intermediate material, can clean a further material, for example of a metal object, or a further plastic material, for example an injection-molding material, or of a plastic object, and/or can form a chemical bond therewith. The at least one functional group produced from the polymer chain of the at least one thermally reversibly cleavable polymer can be, for example, a radical group and/or an acid and/or basic group, for example a carboxylic acid group and/or amine group.

In particular, that portion of the plastic material which is brought into contact with the substrate can therefore be heated to a temperature that is high enough to form a chemical bond to the substrate or further material, and/or to bring about cleaning of the substrate or further material.

Suitable, in particular thermally cleavable, polymers can be thermally cleaved, for example depolymerized and/or radicalized and/or linking initiated and/or linking activated, in particular depolymerized and/or radicalized, for example, at temperatures above 200° C., in particular above 250° C., for example above 300° C., e.g. above 350° C.

In the context of an embodiment, that portion of the plastic material which is brought into contact with the substrate is therefore heated, in particular in method task c), at least to a temperature >200° C. For example, that portion of the plastic material which is brought into contact with the substrate can be heated, in particular in method task c), at least to a temperature ≧250° C. For example, that portion of the plastic material which is brought into contact with the substrate can be heated, in particular in method task c), to a temperature (at least) ≧300° C. or ≧350° C. or ≧400° C. For example, that portion of the plastic material which is brought into contact with the substrate can be heated, in particular in method task c), to a temperature in a range of >200° C. or ≧250° C. or ≧300° C. or ≧350° C. or ≧400° C. and ≦550° C. or ≦500° C. or ≦450° C.

In principle, that portion of the plastic material which is brought into contact with the substrate can be heated, before the plastic material is brought into contact with the substrate, in particular in method task b), to the temperature (cleavage temperature) at which the at least one thermally reversibly cleavable becomes cleaved. Care should be taken in this context, however, that the temperature prior to bringing into contact with the substrate is maintained at, or the temperature prior to bringing into contact with the substrate does not drop below, the temperature at which the at least one thermally reversibly cleavable polymer becomes cleaved or below which the thermally cleaved polymer re-forms.

In order to simplify the method, however, in particular in terms of temperature management, it is also possible to heat that portion of the plastic material which is brought into contact with the substrate, while in contact with the substrate, to a temperature at which the at least one thermally reversibly cleavable polymer becomes cleaved.

In the context of an embodiment, heating of the portion of the plastic material is accomplished in the context of a method task c). Method task c) can be carried out, for example, before and/or during and/or after method task b), and/or before and/or during and/or after method task b1), and/or during and/or after method task x), and/or before and/or during and/or after method task y). Method task c) can be, for example, a thermal post-treatment.

Heating of the portion of the plastic material, in particular in method task c), can be carried out, for example, by way of a method based on induction and/or on electrical current.

In the context of a further embodiment, heating of the portion of the plastic material, in particular in method task c), is accomplished by indirect and/or direct heating. For example, heating of the portion of the plastic material, in particular in method task c), can be accomplished by electromagnetic induction and/or eddy current and/or alternating current (AC) and/or direct current (DC), and/or by way of electromagnetic radiation, for example a laser, and/or via microwaves and/or infrared (IR) radiation. The portion of the plastic material can be heated directly, for example by way of the methods above, and/or indirectly, for example via a material adjacent thereto, for example of the substrate and/or of the further plastic material, or of the (further) object.

The adhesive-bonding or adhesion mechanism between the different layers can advantageously be activated with these methods. In particular, with these methods it is possible to achieve temperatures at which the at least one thermally reversibly cleavable polymer becomes thermally cleaved, for example depolymerized and/or radicalized and/or linking initiated and/or linking activated, in particular depolymerized and/or radicalized. In addition, these methods can advantageously be utilized economically.

In particular, with these methods, advantageously, (only) a specific portion of the plastic material, for example the surface or interface thereof, in particular with respect to the substrate and optionally to a further material, can be heated. Another portion of the plastic material, for example the bulk of the plastic material or of the substrate or of the further material, for example of the further plastic material or of the object, can advantageously remain at temperatures below the cleavage temperature. This can have advantageous effects on the material properties of the other portion of the plastic material or of the substrate or of the further material, and on the properties of the article.

For heating by electromagnetic induction and/or eddy current and/or alternating current and/or direct current, the substrate and/or that portion of the plastic material and/or of the further plastic material and/or of the body which is to be heated can be, in particular, electrically conductive, for example electrically conducting. Electrically conductive or conducting materials, such as metals, can be heated by direct application of an electrical current, for example an alternating current or a direct current, and/or indirectly by electromagnetic induction and/or eddy current.

For example, the substrate can be metallic. Alternatively or in addition thereto, the plastic material and/or the further plastic material and/or the object, in particular that portion of the plastic material and/or further plastic material and/or object which is to be heated, can be electrical conductive and/or conducting. This can be achieved, for example, with electrical conduction additives and/or intrinsically conductive polymers. Alternatively or in addition thereto, a material adjacent to the plastic material and/or to the further plastic material, for example of the object, for example a metal object, can be electrically conductive or conducting.

For heating by electromagnetic radiation, for example, a laser can be used, for example utilizing standard equipment for laser welding.

It is likewise possible, however, for heating by electromagnetic radiation, to use an electromagnetic radiation other than the laser type, for example microwaves or infrared radiation.

For heating via electromagnetic radiation, for example a laser, and/or with microwaves and/or infrared radiation, the substrate and/or that part of the plastic material to be heated and/or a further material, for example the further plastic material and/or the object, can, for example, be configured for absorption of the radiation to be used. For example, the substrate and/or the plastic material, in particular that portion of the plastic material to be heated and/or the further material, for example the further plastic material and/or the object, can be laser-absorbing or microwave-absorbing or infrared-absorbing. For example, the substrate and/or the object can be metallic, for example in order to absorb microwaves. Alternatively or in addition thereto, the plastic material and/or the further plastic material and/or the plastic substrate and/or the plastic object, in particular that portion of the plastic material and/or of the further plastic material and/or of the plastic substrate and/or of the plastic object which is to be heated, can contain additives that are configured for absorption of the radiation to be utilized. For example, electrical conduction additives and/or intrinsically conductive polymers can be used for the absorption of microwaves.

Methods for heating by alternating current (AC) and/or direct current (DC) can be, in particular, active methods, for example in which a direct, in particular electrical, contacting, for example of the plastic material and/or substrate and/or further material, is necessary.

Methods for heating by electromagnetic induction and/or eddy current can advantageously be passive or inactive methods, for example in which no, in particular direct, contacting is necessary.

The heating can therefore in particular be accomplished, in particular in method task c), by electromagnetic induction and/or eddy current.

Surface effects, called “skin effects,” can advantageously be achieved using eddy current.

Using electromagnetic induction, for example with an induction coil, layers located lower down can moreover advantageously also be heated. The heating depth can advantageously be adjusted by adjusting the excitation frequency.

In addition, heating by electromagnetic induction can be regulated in such a way that only a minimal volume of the material is heated, and only a minimal residual heat is produced. On the one hand, thermal deformation of the geometry of the article can thus advantageously be avoided, and optionally the treated item can in fact be touchable, for example immediately, after shutoff.

In the context of an embodiment, heating is therefore accomplished, in particular in method task c), by electromagnetic induction.

As already explained, the result that can advantageously achieved with the aforesaid heating methods is that a portion of the plastic material and/or of the further plastic material and/or of the substrate and/or of the object other than the portion to be heated can maintain a temperature below the cleavage temperature and, for example, also below its own melting temperature or softening temperature. This can refer in particular to the bulk of the plastic material and/or of the substrate and/or of the further plastic material and/or of the object. A “bulk” of a material can be understood in particular as the greatest portion, in terms of volume and/or mass, of the material. The heated portion of the plastic material and/or of the further plastic material and/or of the substrate and/or of the object can be in particular an interface of the plastic material and/or of the further plastic material and/or of the substrate and/or of the object.

Upon heating of a portion of the plastic material and/or of the further plastic material and/or of the substrate and/or of the object, in particular in method task c), the bulk of the plastic material and/or the bulk of the further plastic material and/or the bulk of the substrate and/or the bulk of the object can therefore, for example, maintain a temperature that is below the temperature to which the at least one thermally reversibly cleavable polymer or thermally reversibly cleavable polymers, for example of the plastic material and/or optionally of the further plastic material and/or optionally of the plastic substrate and/or optionally of the plastic object is or are heated. For example, the bulk of the plastic material and/or the bulk of the further plastic material and/or the bulk of the substrate and/or the bulk of the object can be heated, in particular in method task c), at most to a temperature that is below the cleavage temperature of the material thereof, for example of the plastic material or of the further plastic material or of the plastic substrate or of the plastic object. For example, in particular in method task c), the bulk of the plastic material and/or the bulk of the further plastic material and/or the bulk of the substrate and/or the bulk of the object can be heated at most to a temperature that is below the cleavage temperature at which the at least one thermally reversibly cleavable polymer of the respective material, for example of the plastic material or of the further plastic material or of the plastic substrate or of the plastic object, becomes cleaved. In particular, the bulk of the plastic material and/or the bulk of the further plastic material and/or the bulk of the substrate and/or the bulk of the object can be heated at most to a temperature that is below the melting temperature and/or softening temperature of the plastic material or of the further plastic material or of the material of the substrate or of the material of the object. Optionally, the bulk of the plastic material and/or the bulk of the further plastic material and/or the bulk of the substrate and/or the bulk of the object can be heated at most to a temperature that is below the melting temperature and/or softening temperature of the at least one thermally reversibly cleavable polymer or of the thermally reversibly cleavable polymers. For example, the bulk of the plastic material and/or the bulk of the further plastic material and/or the bulk of the substrate and/or the bulk of the object can be, for example substantially, at ambient temperature or room temperature during heating, in particular in method task c). “Substantially” can be understood in this instance in particular as a temperature window of +/−10 K.

For example, the bulk of the plastic material and/or the further plastic material and/or of the material of the substrate and/or of the material of the object can have, in particular while a portion, in particular an interface, of the plastic material and/or of the further plastic material and/or of the material of the substrate and/or the material of the object has a temperature at which the at least one thermally reversibly cleavable polymer or thermally reversibly cleavable polymers of the plastic material and/or of the further plastic material and/or of the plastic substrate and/or of the plastic object becomes or become cleaved, a temperature below that temperature (cleavage temperature) and in particular below the melting temperature and/or softening temperature of the at least one thermally reversibly cleavable polymer of the plastic material and/or of the further plastic material and/or of the plastic substrate and/or of the plastic object. For example, the bulk of the plastic material can be, in particular while that segment which is in or is to be brought into contact with the substrate is at a temperature at which the at least one thermally reversibly cleavable polymer of the plastic material becomes cleaved, in particular substantially at ambient temperature or room temperature.

For example, during heating, for example after injection molding, a portion, in particular an interface, of the plastic material and/or of the further plastic material and/or of the substrate and/or of the object, for example an interface between the substrate and plastic material and/or further plastic material and/or object, for example an interface between the substrate and injection-molding material, can be heated to a temperature that is higher than the melting temperature and/or softening temperature and in particular is also higher than the cleavage temperature of the material, for example of the injection-molding material. Optionally, however, the bulk of the respective material, for example of the injection-molding material, remains below its melting temperature and/or softening temperature. For example, during heating the substrate and/or the object can be heated in such a way that its temperature is higher than the melting temperature and/or softening temperature of the plastic material and/or of the further plastic material, for example injection-molding material. The bulk of the plastic material and/or further plastic material, for example injection-molding material, can, however, remain below its melting temperature and/or softening temperature.

Optionally the plastic material and/or the substrate can be configured to at least 100% more thermal energy upon heating, in particular in method task c), for example post-treatment thermal energy, than the further plastic material, for example injection-molding material, or the material of the object.

Depending on the thermal post-treatment method, a plastic material or further plastic material serving as an intermediate material can, for example, be configured to absorb significantly more energy than a plastic material or further plastic material serving as an injection-molding material. This offers a further possibility for achieving the result that the plastic material serving as an intermediate material becomes heated whereas the bulk of the plastic material serving as an injection-molding material does not become heated.

Depending on the thermal post-treatment method, a plastic material or further plastic material serving as an injection-molding material can, for example, be configured to absorb significantly less energy than the substrate and/or the plastic material or further plastic material serving as an intermediate material. This offers a further possibility for achieving the result that the substrate and/or the plastic material serving as an intermediate material becomes heated whereas the bulk of the plastic material serving as an injection-molding material does not become heated.

Heating, in particular in method task c), can be accomplished, for example, in such a way that the interface or surface of the substrate and/or of the plastic material, for example of the injection-molding material or intermediate material, and/or of the further plastic material, for example of the injection-molding material, and/or of the object, becomes heated within a time span ≦1 s, which may be ≦10 ms, to a temperature ≧200° C. or ≧250° C., in particular ≧300° C. or ≧350° C. or ≧400° C. Joining can thereby advantageously be implemented very quickly, and a very short throughput time can be achieved. Heating of this kind is possible, for example, by electromagnetic induction. Advantageously, the bulk of the substrate and/or of the plastic material, for example of the injection-molding material or intermediate material, and/or of the further plastic material, for example of the injection-molding material, and/or of the object, serves as a heat sink. This in turn advantageously makes it possible, for example after heat delivery has been shut off, to cool the interface or surface, for example, within ≦2 s to ≦300° C. and/or within ≦5 s to <200° C.

In the context of a special embodiment, for indirect heating of the plastic material and/or of the further plastic material and/or of the plastic substrate and/or of the plastic object, in particular only, a metallic portion of the composite to be formed, in particular the object and/or the substrate and/or the further substrate, is heated. This can be achieved, for example, by low-frequency heating, for example at approximately 50 Hz, for example by inductive low-frequency heating and/or by the application of eddy current.

In particular, for example in method task c), the interface of the substrate and/or of the plastic material, for example of the injection-molding material or intermediate material, and/or of the further plastic material, for example of the injection-molding material, and/or of the object, can be surrounded by a low-oxygen and/or low-water or dry atmosphere. Degradation of the plastic material and/or of the further plastic material and/or of the substrate and/or of the object by oxidation and/or hydrolysis can thereby advantageously be prevented, even at such high temperatures.

The at least one thermally reversibly cleavable polymer of the plastic material and/or the at least one thermally reversibly cleavable polymer of the plastic substrate and/or the at least one thermally reversibly cleavable polymer of the further plastic material and/or the at least one thermally reversibly cleavable polymer of the plastic object can in principle be both different from one another and identical in nature. However, the at least one thermally reversibly cleavable polymer of the plastic material and/or the at least one thermally reversibly cleavable polymer of the plastic substrate and/or the at least one thermally reversibly cleavable polymer of the further plastic material and/or the at least one thermally reversibly cleavable polymer of the plastic object may be thermally reversibly cleavable at similar temperatures. For example, the temperatures at which the at least one thermally reversibly cleavable polymer of the plastic material and/or the at least one thermally reversibly cleavable polymer of the plastic substrate and/or the at least one thermally reversibly cleavable polymer of the further plastic material and/or the at least one thermally reversibly cleavable polymer of the plastic object are thermally reversibly cleavable are within a temperature range (from one another) of less than or equal to 40 Kelvin, for example in a temperature range of less than or equal to 20 Kelvin.

The at least one thermally reversibly cleavable polymer of the plastic material and/or of the plastic substrate and/or of the further plastic material and/or of the plastic object can be, for example, a thermoplastic or a thermosetting plastic.

In particular, the at least one thermally reversibly cleavable polymer of the plastic material and/or of the plastic substrate and/or of the further plastic material and/or of the plastic object can have bond-forming functional groups, generatable by thermal cleavage, for example depolymerization and/or radicalization and/or linking initiation and/or linking activation, in the polymer chain. A good adhesive effect can advantageously be achieved as a result of the bond-forming functional groups generatable by thermal cleavage, for example depolymerization and/or radicalization and/or linking initiation and/or linking activation.

Optionally, the at least one thermally reversibly cleavable polymer of the plastic material and/or of the plastic substrate and/or of the further plastic material and/or of the plastic object can additionally already have bond-forming functional groups, for example epoxy groups and/or epichlorohydrin, even before thermal cleavage, for example depolymerization and/or radicalization and/or linking initiation or linking activation. The adhesive effect, for example of an injection-molding material and/or of an intermediate material, can thereby advantageously be intensified by additional bonds.

If the plastic material serves as an intermediate material, the bond-forming functional groups can be configured, for example, for bonding to a plastic material serving as an injection-molding material. If the plastic material serves as an injection-molding material, the bond-forming functional groups can be configured, for example, for bonding to a plastic material serving as an intermediate material and/or to the substrate.

In the context of a further embodiment, the at least one thermally reversibly cleavable polymer of the plastic material and/or of the plastic substrate and/or of the further plastic material and/or of the plastic object is selected, in particular mutually independently, from the group of, in particular, amide- and/or imide- and/or carboxylic acid- and/or carboxylic acid anhydride-functionalized, optionally grafted and/or crosslinked polymers, for example maleinate resins, polyamides, polyimides, polyamide-imides, polyesters, epoxy resins, polyurethanes, aminoplasts, polyoxymethylene (POM), polystyrene (PS), polymethyl methacrylate (PMMA), and combinations or mixtures thereof.

These polymers can advantageously be used as intermediate materials and/or as an injection-molding material and/or as a material of the plastic material and/or of the plastic substrate and/or of the further plastic material and/or of the plastic object. A good adhesive or adhesive-bonding effect can advantageously be achieved with these polymers. In addition, these polymers can be economical, easy to apply, and robust during handling, for example between an initial application, curing, and/or during the injection molding process.

Chemical, in particular covalent, bonds between mutually adjacent plastic materials can be formed by way of amide groups and/or imide groups and/or carboxylic acid groups and/or carboxylic acid anhydride groups. A very strong adhesive effect can thereby advantageously be achieved. For example, a polymer that has free acid groups, for example in side chains, can be used.

Polymers of this kind can be used particularly advantageously as a plastic material or further plastic material serving as intermediate material, in combination with a polyamide and/or polyester as an injection-molding material. Free acid groups can, for example, enter into an exchange reaction, for example with a polymer chain of an adjacent plastic material, for example of an injection-molding material, and/or can dissolve passivation layers from metallic materials. Polyimide/amide can, for example, have sufficient free acid groups to enter into an exchange reaction with the polymer chain of the injection-molding material.

For example, the at least one thermally reversibly cleavable polymer of the plastic material and/or of the plastic substrate and/or of the further plastic material and/or of the plastic object can be selected from the group of amide- and/or imide- and/or carboxylic acid- and/or carboxylic acid anhydride-functionalized, optionally grafted and/or crosslinked polymers that are obtainable via Diels-Alder reaction and/or polymerization of unsaturated organic monomers. At least one monomer selected from the group of unsaturated dicarboxylic acid derivatives, for example maleic acid and/or maleic acid anhydride and/or derivatives thereof, and/or abietic acid and/or olefins, can be used, for example, in this context. For example, the at least one thermally reversibly cleavable polymer of the plastic material and/or of the plastic substrate and/or of the further plastic material and/or of the plastic object can be selected from the group of amide- and/or imide- and/or carboxylic acid- and/or carboxylic acid anhydride-functionalized, optionally grafted and/or crosslinked maleic acid polymers and/or polyolefins, for example maleic acid homopolymers and/or propylene and/or polyethylene.

Polymers obtained by Diels-Alder reaction, for example maleinate resins, e.g. Diels-Alder addition compounds of maleic acid anhydride optionally with abietic acid, can advantageously be particularly effectively thermally reversibly cleaved and repolymerized. Grafted thermoplastics, in particular polyolefins, can advantageously likewise be effectively thermally reversibly cleaved and repolymerized. Thermally unstable side chains in particular can be cleaved, in which context upon cleavage thereof the main chain can advantageously largely remain unchanged.

For example, the at least one thermally reversibly cleavable polymer of the plastic material and/or of the plastic substrate and/or of the further plastic material and/or of the plastic object can encompass or be a maleic acid polymer, for example a maleic acid homopolymer, e.g. an amine-neutralized maleic acid homopolymer, and/or a maleinate resin. Maleic acid polymers or maleinate resins can be thermally reversibly cleaved, for example, above a temperature approximately ≧300°, for example up to approximately ≦500° C.

Alternatively or in addition thereto, the at least one thermally reversibly cleavable polymer of the plastic material and/or of the plastic substrate and/or of the further plastic material and/or of the plastic object can encompass or be a carboxylic acid- and/or carboxylic acid anhydride-grafted polyolefin, for example a maleic acid anhydride- and/or acrylic acid-grafted polyolefin, for example polypropylene and/or polyethylene. Acrylic acid-grafted polypropylene can be thermally reversibly cleaved, for example, above a temperature approximately ≧220° C., in particular approximately ≧250° C., for example up to approximately ≦450° C. Maleic acid anhydride-grafted polypropylene can be thermally reversibly cleaved, for example, above a temperature approximately ≧260° C., in particular approximately ≧300° C., for example up to approximately ≦450° C.

Alternatively or in addition thereto, the at least one thermally reversibly cleavable polymer of the plastic material and/or of the plastic substrate and/or of the further plastic material and/or of the plastic object can encompass or be a polyamide, for example polyamide 6,6 (PA66). Polyamides can be thermally reversibly cleaved, for example, above a temperature approximately ≧350° C., for example up to approximately ≦450° C. Polyamides can advantageously be effectively bonded by thermal cleavage, in particular depolymerization. Polyamides can be used, among other things, as an injection-molding material.

Alternatively or in addition thereto, the at least one thermally reversibly cleavable polymer of the plastic material and/or of the plastic substrate and/or of the further plastic material and/or of the plastic object can encompass or be a polyimide. Polyimides can be thermally reversibly cleaved, for example, above a temperature approximately ≧400° C., for example up to approximately ≦500° C.

Alternatively or in addition thereto, the at least one thermally reversibly cleavable, polymer of the plastic material and/or of the plastic substrate and/or of the further plastic material and/or of the plastic object can encompass or be a polyamide-imide.

Alternatively or in addition thereto, the at least one thermally reversibly cleavable polymer of the plastic material and/or of the plastic substrate and/or of the further plastic material and/or of the plastic object can encompass or be a polyester, for example polybutylene terephthalate (PBT). Polyesters can be thermally reversibly cleaved, for example, above a temperature ≧250° C., in particular approximately ≧300° C., for example up to approximately ≦400° C. For example, polybutylene terephthalate (PBT) can be thermally reversibly cleaved above a temperature approximately ≧250° C., in particular approximately ≧300° C., for example up to approximately ≦400° C. Polyesters can be used, among other things, as an injection-molding material.

Alternatively or in addition thereto, the at least one thermally reversibly cleavable polymer of the plastic material and/or of the plastic substrate and/or of the further plastic material and/or of the plastic object can encompass or be an epoxy resin.

Alternatively or in addition thereto, the at least one thermally reversibly cleavable polymer of the plastic material and/or of the plastic substrate and/or of the further plastic material and/or of the plastic object can encompass or be a polyurethane.

Alternatively or in addition thereto, the at least one thermally reversibly cleavable polymer of the plastic material and/or of the plastic substrate and/or of the further plastic material and/or of the plastic object can encompass or be an aminoplast. For example, the at least one thermally reversibly cleavable polymer of the plastic material and/or of the plastic substrate and/or of the further plastic material and/or of the plastic object can encompass or be an aminoplast obtainable by reacting a carbonyl compound, for example formaldehyde, and an amine, for example urea and/or melamine and/or benzoguanamine. For example, the at least one thermally reversibly cleavable polymer of the plastic material and/or of the plastic substrate and/or of the further plastic material and/or of the plastic object can encompass or be a melamine resin.

Alternatively or in addition thereto, the at least one thermally reversibly cleavable polymer of the plastic material and/or of the plastic substrate and/or of the further plastic material and/or of the plastic object can encompass or be polyoxymethylene (POM). Polyoxymethylene (POM) can be thermally reversibly cleaved, for example, above a temperature approximately ≧250° C., in particular approximately ≧300° C., for example up to approximately ≦450° C.

Alternatively or in addition thereto, the at least one thermally reversibly cleavable polymer of the plastic material and/or of the plastic substrate and/or of the further plastic material and/or of the plastic object can encompass or be polystyrene (PS). Polystyrene (PS) can be thermally reversibly cleaved, for example, above a temperature approximately ≧230° C., in particular approximately ≧300° C., for example up to approximately ≦450° C.

Alternatively or in addition thereto, the at least one thermally reversibly cleavable polymer of the plastic material and/or of the plastic substrate and/or of the further plastic material and/or of the plastic object can encompass or be polymethyl methacrylate (PMMA). Polymethyl methacrylate (PMMA) can be thermally reversibly cleaved, for example, above a temperature approximately ≧330° C., in particular approximately ≧350° C., for example up to approximately ≦450° C.

Optionally, the at least one thermally reversibly cleavable polymer of the plastic material and/or of the plastic substrate and/or of the further plastic material and/or of the plastic object can contain at least one initiator, in particular to initiate repolymerization. For example, the at least one initiator can be a radical, cationic, or anionic, for example radical, initiator.

Optionally, the at least one thermally reversibly cleavable polymer of the plastic material and/or of the plastic substrate and/or of the further plastic material and/or of the plastic object can contain at least one catalyst, in particular to catalyze repolymerization. For example, the at least one catalyst can be a radical, cationic, or anionic, for example radical, catalyst.

In the context of an embodiment, the at least one thermally reversibly cleavable polymer of the plastic material and/or of the plastic substrate and/or of the further plastic material and/or of the plastic object encompasses a maleic acid polymer. Optionally, the at least one thermally reversibly cleavable polymer of the plastic material and/or of the plastic substrate and/or of the further plastic material and/or of the plastic object can be a maleic acid polymer. In particular, the maleic acid polymer can have an average molecular weight (MW) of ≧1000 Dalton to ≦60,000 Dalton, for example of approximately 2000 or 50,000 Dalton. The maleic acid polymer can be, for example, a maleic acid homopolymer.

For example, the maleic acid polymer can be an, in particular partially, amine-neutralized maleic acid polymer, in particular maleic acid homopolymer, for example having an average molecular weight (MW) of ≧1000 Dalton to ≦60,000 Dalton. The partially amine-neutralized maleic acid polymer, in particular maleic acid homopolymer, can have, for example, a degree of neutralization in a range from ≧20 mol % to ≦40 mol %, for example of approximately 30 mol % or approximately 25 mol %. For example, the maleic acid polymer, in particular maleic acid homopolymer, can be neutralized with a diamine or polyamine and/or a difunctionalized or polyfunctionalized amine having an alcohol function, for example dihexamethylenetriamine and/or monoethanolamine. Advantageously, crosslinking can be achieved as a result of neutralization with difunctionalized or polyfunctionalized amines. Optionally, such polymers can also be referred to as an “acid amide.” As a result of the many free acid groups, such polymers can advantageously enter into an exchange reaction, for example with a polymer chain of an adjacent plastic material, for example an injection-molding material, for example when the adjacent plastic material, for example an injection-molding material, is cleaved, for example depolymerized and/or radicalized and/or linking initiated and/or linking activated, in particular depolymerized and/or radicalized, during heating. Alternatively or in addition thereto, such polymers can advantageously, as a result of the many free acid groups, dissolve passivation layers from metallic materials. In addition, such polymers can exhibit a strong adhesive force in the context of metals, such as stainless steels, and can optionally form chemical bonds and/or complexes with some metals, such as copper (Cu). Such polymers can be used particularly advantageously as a plastic material or further plastic material serving as an intermediate material, in combination with a polyamide and/or polyester as an injection-molding material.

The plastic material and/or the further plastic material can optionally be applied in the form of an aqueous solution. For example, an aqueous solution of the plastic material and/or of the further plastic, material can be used for coating, for example in method task b) and/or optionally x). Optionally, the aqueous solution can contain at least one wax, for example in a small quantity. The handling properties of a coating formed therefrom, for example during solidification/curing and/or injection molding, can thereby advantageously be improved.

With regard to further technical features and advantages of the method according to the present invention, reference is hereby made explicitly to the explanations in conjunction with the plastic/substrate composite according to the present invention, the polymer according to the present invention, and the use according to the present invention, and to the Figures and the description of the Figures.

The invention furthermore relates to a plastic/substrate composite that is manufactured by way of a method according to the present invention. The composite can be, for example, a metal/plastic composite, for example a metal/injection-molded composite, or a metal/metal composite, in particular a metal/metal composite adhesively bonded via at least one plastic material, or a plastic/plastic composite, optionally a plastic/plastic composite adhesively bonded via at least one plastic material. The plastic/substrate composite can be, for example, a seal, for example a sensor seal, or a sensor, for example a rotation speed sensor such as a wheel rotation speed sensor, or a knock sensor, or a tube connection.

With regard to further technical features and advantages of the plastic/substrate composite according to the present invention, reference is hereby made explicitly to the explanations in conjunction with the method according to the present invention, the polymer according to the present invention, and the use according to the present invention, and to the Figures and the description of the Figures.

A further subject of the invention is a maleic acid polymer. The maleic acid polymer can in particular be a maleic acid homopolymer. For example, the maleic acid polymer can have an average molecular weight (MW) of ≧1000 Dalton to ≦60,000 Dalton, for example of approximately 2000 Dalton or 50,000 Dalton. For example, the maleic acid polymer can be an, in particular partially, amine-neutralized maleic acid polymer, in particular maleic acid homopolymer, for example having an average molecular weight (MW) of ≧1000 Dalton to ≦60,000 Dalton. The partially amine-neutralized maleic acid polymer, in particular maleic acid homopolymer, can have, in particular, a degree of neutralization in a range from ≧20 mol % to ≦40 mol %, for example of approximately 30 mol % or approximately 25 mol %. For example, the maleic acid polymer, in particular maleic acid homopolymer, can be neutralized with a diamine or polyamine and/or a difunctionalized or polyfunctionalized amine having an alcohol function, for example dihexamethylenetriamine and/or monoethanolamine. Advantageously, crosslinking can be achieved as a result of neutralization with difunctionalized or polyfunctionalized amines. Optionally, such polymers can also be referred to as an “acid amide” (or “polyamide-imide”). As a result of the many free acid groups, such polymers can advantageously enter into an exchange reaction, for example with a polymer chain of an adjacent plastic material, for example an injection-molding material, for example when the adjacent plastic material, for example an injection-molding material, is cleaved, for example depolymerized and/or radicalized and/or linking initiated and/or linking activated, in particular depolymerized and/or radicalized, during heating, and/or can dissolve passivation layers from metallic materials. In addition, such polymers can exhibit a strong adhesive force in the context of metals, such as stainless steels, and can optionally form chemical bonds and/or complexes with some metals, such as copper (Cu). Such polymers can be used particularly advantageously as a plastic material or further plastic material serving as an intermediate material, in combination with a polyamide and/or polyester as an injection-molding material.

For example, the maleic acid polymer can be used as a plastic material, in particular as a plastic material serving as an intermediate material, or as a further plastic material, in particular as a further plastic material serving as a further intermediate material, in the context of the method according to the present invention and the use according to the present invention.

With regard to further technical features and advantages of the polymer according to the present invention, reference is hereby made explicitly to the explanations in conjunction with the method according to the present invention, the plastic/substrate composite according to the present invention, and the use according to the present invention, and to the Figures and the description of the Figures.

The invention further relates to the use of a thermal cleavage, for example depolymerization and/or radical formation (radicalization) and/or linking initiation and/or (linking) activation, of a thermally reversibly cleavable polymer and/or of a reflow polymer chain member exchange or green space (block) copolymerization and/or grafting reaction between at least two thermally reversibly cleavable polymers, for adhesive bonding. In particular, metal and plastic or metal and metal or plastic and plastic can thereby be adhesively bonded. For example, tubes can thereby be adhesively bonded, and in particular joined, to one another. The thermally reversibly cleavable polymers explained in the context of the method according to the present invention can be used, for example, for this. Polymers obtainable by Diels-Alder reaction and/or grafted thermoplastics can be used, for example.

With regard to further technical features and advantages of the use according to the present invention, reference is hereby made explicitly to the explanations in conjunction with the method according to the present invention, the plastic/substrate composite according to the present invention, and the polymer according to the present invention, and to the Figures and the description of the Figures.

Further advantages and advantageous embodiments of the subjects of the present invention are illustrated by the drawings and examples, and are explained in the description that follows. It is to be noted in this context that the drawings and examples are merely descriptive in nature and are not intended to limit the present invention in any way.

### BRIEF DESCRIPTION OF THE DRAWINGS

FIG. 1 is a flow chart to illustrate some embodiments of the method according to the present invention.

FIG. 2 is a schematic cross section through an embodiment of a composite according to the present invention in the form of a metal/plastic composite.

FIG. 3 is a schematic cross section through a further embodiment of a composite according to the present invention in the form of a plastic/plastic composite.

FIG. 4 shows schematic cross sections through further embodiments of composites according to the present invention in the form of metal/intermediate material/plastic composites, as well as manufacturing variants therefor.

FIG. 5 shows schematic cross sections through further embodiments of composites according to the present invention in the form of plastic/intermediate material/plastic composites, as well as manufacturing variants therefor.

FIG. 6 shows schematic cross sections through further embodiments of composites according to the present invention in the form of metal/intermediate material/metal composites, as well as manufacturing variants therefor.

FIG. 7 is a schematic cross section through a further embodiment of a composite according to the present invention in the form of a join between two metal tubes.

FIG. 8 shows schematic cross sections through a further embodiment of a composite according to the present invention in the form of a metal/intermediate material/injection-molding material composite during the manufacture thereof.

FIG. 9 is a schematic cross section through an embodiment of an intermediate layer for a further embodiment of a composite according to the present invention.

FIGS. 10 and 11 show schematic cross sections to illustrate a further embodiment of a method and composite according to the present invention in the form of a tube join between an outer tube and an inner tube via a steel sheet coated on both sides with plastic material, before and after joining by shrinkage of the outer tube onto the inner tube.

### DETAILED DESCRIPTION

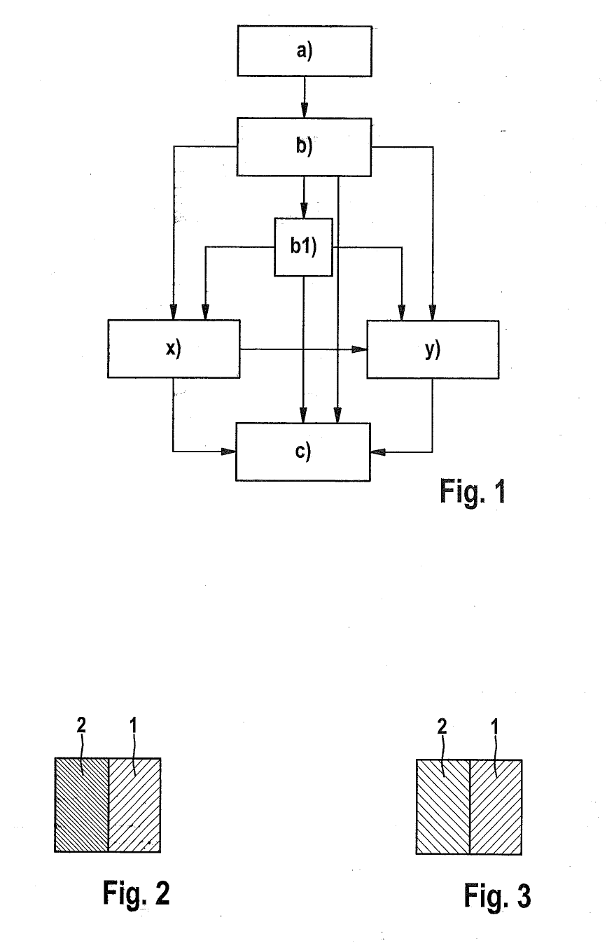

FIG. 1 provides an overview of some embodiments of the method according to the present invention for joining, in particular adhering, plastic to a substrate.

FIG. 1 shows that firstly, in a method task a), a plastic material that encompasses at least one thermally reversibly cleavable polymer is furnished. In a method task b) this plastic material is brought into contact with a substrate. The substrate can be, for example, a metal substrate or a plastic substrate.

In order to achieve an adhesion effect and/or adhesive bonding effect between the plastic material and the substrate, a portion of the plastic material which is brought into contact with the substrate is heated, in particular in a method task c), to a temperature at which the at least one thermally reversibly cleavable polymer of the plastic material becomes cleaved, and is re-cooled while in contact with the substrate.

It is possible in this context to heat that portion of the plastic material which is to be brought into contact with the substrate, before being brought into contact with the substrate, to the temperature at which the at least one thermally reversibly cleavable polymer becomes cleaved, for example in method task c), and then to bring it into contact with the substrate and to cool it while in contact with the substrate (not depicted in FIG. 1).

It is also possible to heat a portion of the substrate, before being brought into contact with the plastic material, for example in method task c), to a temperature that is high enough to heat a portion of the plastic material, when brought into contact with the plastic material, to a temperature at which the at least one thermally reversibly cleavable polymer of the plastic material becomes cleaved, and to re-cool it while in contact with the plastic material (not depicted in FIG. 1).

As shown in FIG. 1, however, method task c) can be carried out in particular after method task b), so that a portion of the plastic material which is brought into or is in contact with the substrate becomes heated to a temperature at which the at least one thermally reversibly cleavable polymer of the plastic material becomes cleaved and re-cools or is re-cooled while in contact with the substrate. This can be achieved, for example, by electromagnetic induction.

In the case of a metal substrate, for example, a portion of the metal substrate adjacent to the plastic substrate can be heated by electromagnetic induction to a temperature that is sufficiently high to heat that part of the plastic material which is adjacent thereto to a temperature at which the at least one thermally reversibly cleavable polymer of the plastic material becomes cleaved. The cleaved polymer units, for example monomers, can penetrate into smaller pores in the surface of the metal substrate than melted polymers, so that on the one hand an improved adhesion effect is achieved. On the other hand, the cleaved polymer units can exhibit passivation layer-dissolving properties and can in that manner further improve the adhesion effect.

In the case of a plastic substrate, for example at least that part of the plastic material which is adjacent to the plastic substrate, and/or at least that part of the plastic substrate which is adjacent to the plastic material, can be electrically conductive and can in that manner be heated by electromagnetic induction. The material of the plastic substrate can optionally also encompass at least one thermally reversibly cleavable polymer. Particularly strong chemical, in particular covalent, bonds can thereby be formed by way of a polymer chain member exchange between the polymer of the plastic material and the polymer of the plastic substrate, and a particularly good adhesive effect can in that manner be achieved.

The plastic material can be applied in method task b), for example, in the form of a coating onto the substrate, or injection-molded as an injection-molding material onto the substrate, or placed as a shaped part or shaped element onto the substrate.

FIG. 1 illustrates that the method can furthermore encompass the method task b1) in which the plastic material becomes completely solidified, in particular fully polymerized or cured, before heating, in particular in method task c). A plastic material applied, for example, as a coating or injection-molding material onto the substrate can thus advantageously be protected from damage during processing thereof, for example between application onto the substrate and heating.

FIG. 1 further illustrates that the method can encompass, alternatively or in addition to method task b1), the method task x) of applying a further plastic material onto the plastic material. The further plastic material can, in method task x), for example be overmolded in the form of an injection-molding material onto the plastic material, or can be applied in the form of a coating onto the plastic material, or overmolded as an injection-molding material onto the substrate, or placed as a shaped part or shaped element onto the substrate. In particular if the plastic material is embodied in the form of a coating and the further plastic material is applied by injection molding, it can be advantageous to completely solidify, for example cure, the plastic material in method task b1). The plastic material can thus advantageously not deform during injection molding of the further plastic material, and injection molding is thus simplified and/or the quality of the composite to be manufactured is thus improved. The further plastic material can optionally likewise encompass a thermally reversibly cleavable polymer. Particularly strong chemical, in particular covalent, bonds can thus be formed by a polymer chain member exchange between the polymer of the plastic material and the polymer of the further plastic material, and a particularly good adhesive effect can be achieved in this manner.

FIG. 1 illustrates that the method can further encompass, alternatively or in addition to method task b1) and alternatively or in addition to method task x), the method task y) of bringing the plastic material or the further material into contact with an object or bringing the plastic material into contact with an object equipped with the further plastic material. The object can be, for example, a metal object or a plastic object. If the object is equipped with the further plastic material, the object can in particular be brought into contact with the plastic material in such a way that the plastic material and the further plastic material contact one another. The material of the plastic object and/or the further plastic material can optionally likewise encompass at least one thermally reversibly cleavable polymer. Particularly strong chemical, in particular covalent, bonds can thus advantageously be formed by a polymer chain member exchange between the polymer of the plastic material and the polymer of the plastic object and/or the polymer of the further plastic material, and a particularly good adhesive effect can be achieved in this manner.

If the further plastic material and/or the material of the plastic substrate and/or the material of the plastic object likewise encompasses a thermally reversibly cleavable polymer, in method task c) in particular interface-forming parts of the materials can be heated to a temperature at which the respective polymer becomes thermally cleaved.

FIG. 2 shows an embodiment of a plastic/substrate composite according to the present invention in which, by way of a method according to the present invention, a metal substrate 2 has been joined, in particular adhesively bonded, directly to a plastic material 1 encompassing a thermally reversibly cleavable polymer, to yield a metal 2/plastic 1 composite.

FIG. 3 shows an embodiment of a plastic/substrate composite according to the present invention in which, by way of a method according to the present invention, a plastic substrate 2 has been joined, in particular adhesively bonded, directly to a plastic material 1 encompassing a thermally reversibly cleavable polymer, to yield a plastic 2/plastic 1 composite.

In the context of the embodiments shown in FIGS. 2 and 3, plastic material 1 can be embodied, for example, in the form of a shaped plastic part, for example in the form of a plastic handle, which is placed directly onto substrate 2. Alternatively or additionally, plastic material 1 can be applied, for example overmolded or coated, directly onto substrate 2 by injection molding or coating. A direct adhesion and/or adhesive bonding effect between substrate 2 and plastic material 1 can thereby be achieved by heating and re-cooling of the reversibly cleavable polymer.

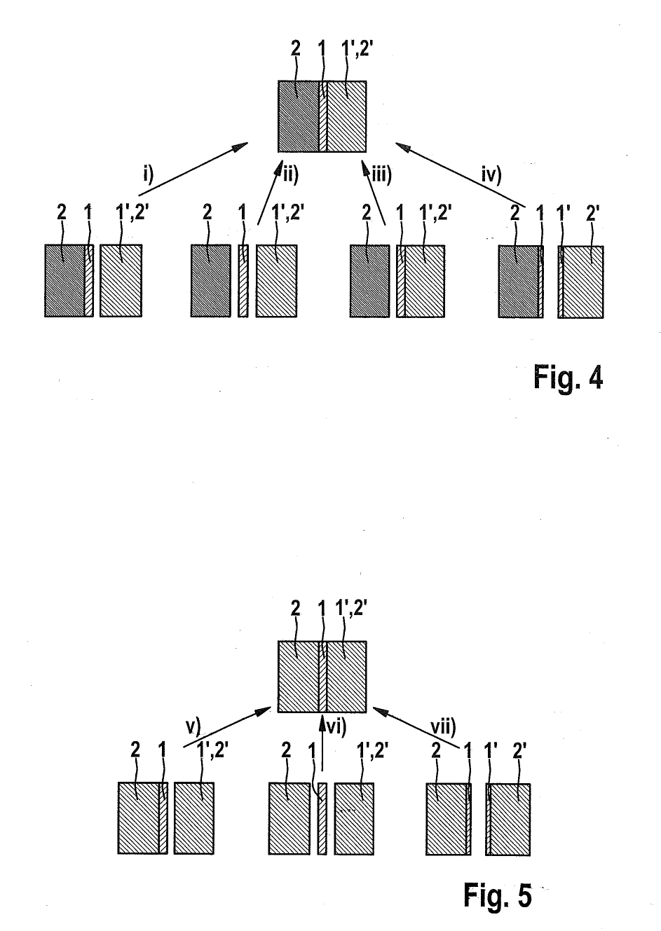

FIGS. 4 to 6 show schematic cross sections through embodiments of composites according to the present invention, and illustrate manufacturing variants therefor.

FIGS. 4 to 6 show composites, manufacturable according to the present invention, in which plastic material 1 encompassing at least one thermally reversibly cleavable polymer serves as an intermediate material and is embodied in the form of an intermediate material layer 1 in order to join, in particular to adhesively bond, a further material 1′, 2′ to substrate 2.

Further material 1′, 2′ can be, for example, a further plastic material 1′, for example an injection-molding material.

The further material can, however, also be an object 2′, for example a plastic object or a metal object, that is optionally equipped with a further plastic material 1′.

Optionally, further plastic material 1′ itself can serve as a further intermediate material and can be embodied in the form of a further intermediate material layer 1′, in particular in order to join, in particular to adhesively bond, an object 2′, for example a plastic object or a metal object, indirectly—namely via intermediate layer 1 made of the plastic material and via further intermediate layer 1′ made of the further plastic material—to substrate 2.

What is used in the context of the embodiments shown in FIG. 4 is a metal substrate 2 that is joined, in particular adhesively bonded, indirectly to a plastic 1′, 2′ by way of a method according to the present invention, via an intermediate material layer 1 made of plastic material 1 encompassing at least one thermally reversibly cleavable polymer. Metal 2/plastic 1′, 2′ composites are therefore shown in particular in FIG. 4.

What is used in the context of the embodiments shown in FIG. 5 is a plastic substrate 2 that is joined, in particular adhesively bonded, indirectly to a plastic 1′, 2′ by way of a method according to the present invention, via an intermediate material layer 1 made of plastic material 1 encompassing at least one thermally reversibly cleavable polymer. Plastic 2/plastic 1′, 2′ composites are therefore shown in particular in FIG. 5.

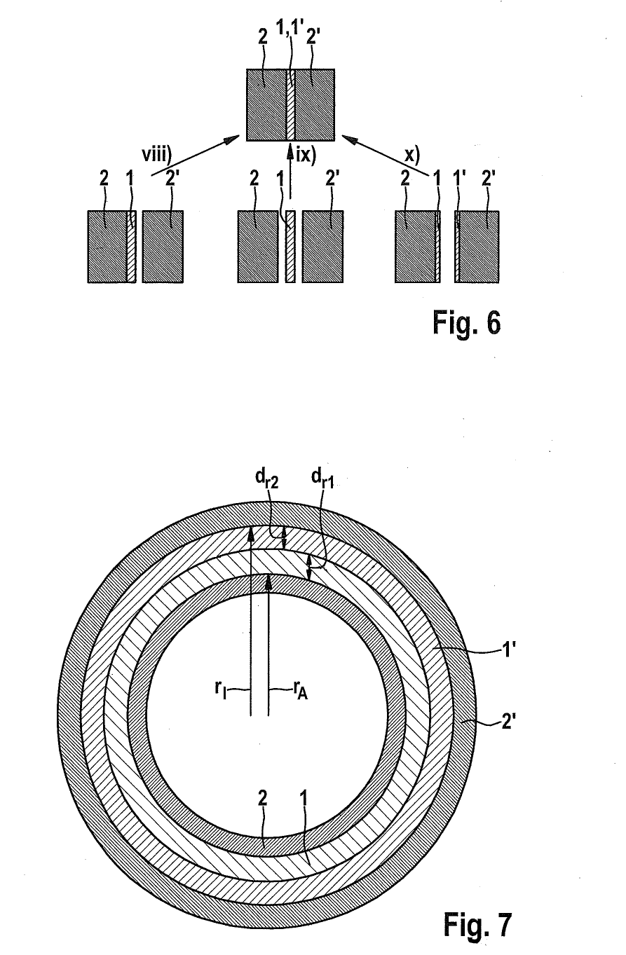

What is used in the context of the embodiments shown in FIG. 6 is a metal substrate 2 that is joined, in particular adhesively bonded, indirectly to a metal 2′ by way of a method according to the present invention, via an intermediate material layer 1 made of plastic material 1 encompassing at least one thermally reversibly cleavable polymer. Metal 2/metal 2′ composites are therefore shown in particular in FIG. 6.

FIGS. 4 to 6 show that in accordance with manufacturing variants i), v), and viii), plastic material 1 serving as an intermediate material is applied onto substrate 2, a further material 1′, 2′ in turn being applied onto plastic material 1 serving as an intermediate material.

If further material 1′, 2′ is a plastic, as in the case of the embodiments shown in FIGS. 4 and 5, the application of further material 1′, 2′ can be accomplished, for example, by injection molding or coating with a further plastic material 1′ or by placement of a plastic object 2′, for example a plastic handle.

If further material 2′ is a metallic material, as in the case of the embodiment shown in FIG. 6, the application of further material 2′ can be accomplished, for example, by placement of a metal object 2′, for example a metal handle.

FIGS. 4 to 6 show that in accordance with manufacturing variants ii), vi), and ix), plastic material 1 serving as an intermediate material can be embodied as a shaped plastic part, for example as a self-supporting plastic layer or plastic film, and can be disposed between substrate 2 and a further material 1′, 2′. Plastic material 1, embodied as a shaped plastic part and serving as an intermediate material, can be placed on the one hand onto substrate 2 and on the other hand onto further material 1′, 2′.

If further material 1′, 2′ is a plastic, as in the case of the embodiments shown in FIGS. 4 and 5, the application of further material 1′, 2′ can be accomplished by the fact that a further plastic material 1′ is applied, for example by injection molding or coating, onto plastic material 1 embodied as a shaped plastic part and serving as an intermediate layer, or is placed in the form of a plastic object 2′, for example a plastic handle, onto plastic material 1 embodied as a shaped plastic part and serving as an intermediate layer.

If further material 2′ is a metallic material, as in the case of the embodiment shown in FIG. 6, the application of further material 2′ can be accomplished, for example, by placement of a metal object 2′, for example a metal handle.

FIG. 4 shows that in accordance with manufacturing variant iii) which is the inverse of manufacturing variant i), and which is also transferrable to the embodiments shown in FIGS. 5 and 6, plastic material 1 serving as an intermediate material can also be applied onto an object 2′ rather than onto substrate 2. In other words it is possible to use an object 2′ that is equipped, for example by coating or injection molding, with plastic material 1 serving as an intermediate material, plastic material 1 with which object 2′ is equipped being brought into contact with substrate 2. For example, plastic material 1 with which object 2′ is equipped can be placed onto substrate 2.

In the context of the embodiment shown in FIG. 4, substrate 2 is a metal substrate and object 2′ is a plastic object. In manufacturing variants (not depicted) analogous to manufacturing variant iii), however, which can also be used, for example, to manufacture the embodiments shown in FIGS. 5 and 6, an object 2′ equipped with plastic material 1 can also be used. In order to manufacture the embodiment shown in FIG. 5, substrate 2 could be a plastic substrate and object 2′ a plastic object, or in order to manufacture the embodiment depicted in FIG. 6, substrate 2 could be a metal substrate and object 2′ a metal object (not depicted).

FIGS. 4 to 6 furthermore show that in accordance with manufacturing variants iv), vii), and x), substrate 2 can be equipped with plastic material 1 serving as an intermediate material and object 2′ can be equipped with a further plastic material 1′ serving as a further intermediate material, plastic material 1 with which substrate 2 is equipped being brought into contact with further plastic material 1′ with which object 2′ is equipped. In principle, plastic material 1′ and further plastic material 1′ can be applied onto substrate 2 or object 2′, respectively separately from one another or together, both as individual shaped plastic parts, for example as self-supporting plastic layers or plastic films, or as combined plastic parts, for example as a self-supporting shaped plastic part, for example a plastic film, configured partly from plastic material 1 and partly from further plastic material 1′ and optionally partly from another material, for example metal, and also by coating or injection molding. If object 2′ is a metal object, as in the context of the embodiment shown in FIG. 6, in particular plastic material 1 can be applied onto substrate 2 and further plastic material 1′ can be applied onto object 2′. The two plastic materials 1, 1′ can thus advantageously serve as protective layers, in particular corrosion protection layers, for the metallic materials of substrate 2 and of object 2′, can remove passivating layers from them, and/or can be specially coordinated with the respective metallic material.

FIG. 7 is a schematic cross section through a further embodiment of a composite according to the present invention in the form of a tube join between two metal tubes 2, 2′. FIG. 7 illustrates that in the context of this embodiment, substrate 2 is embodied in the form of a first, in particular inner, metal tube 2 whose outer side is equipped with a plastic material 1 encompassing at least one thermally reversibly cleavable polymer, an object 2′ being embodied in the form of a second, in particular outer, metal tube whose inner side is equipped with a further plastic material 1′ encompassing at least one thermally reversibly cleavable polymer. Plastic materials 1, 1′ can be configured by coating or injection molding, or as a shaped part or shaped element, for example sleeves.

FIG. 7 illustrates that first metal tube 2 has an outer radius r_{A} that is smaller than the inner radius r_{I} of second metal tube 2′. FIG. 7 illustrates that the outer radius r_{A} of first metal tube 2 is smaller than the inner radius r_{I} of second metal tube 2′ in particular by a magnitude that corresponds to the sum of the radial thickness dᵣ₁ of plastic material 1 and the radial thickness dᵣ₂ of further plastic material 1′.

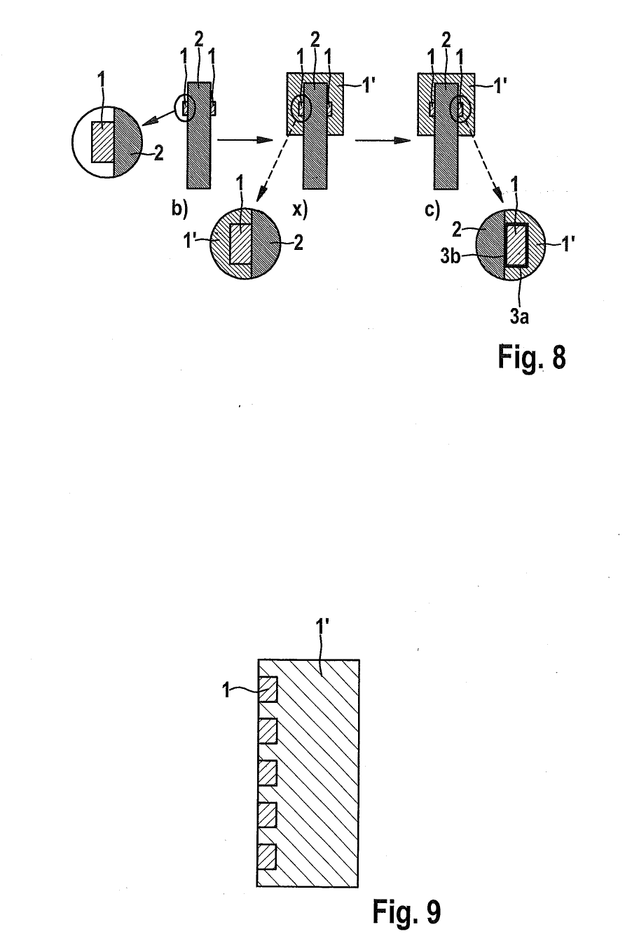

FIG. 8 shows a special embodiment of the method. Here a plastic material 1 that encompasses at least one thermally reversibly cleavable polymer is furnished in method task a), and is applied onto a substrate 2 in method task b). Substrate 2 can be, for example, a metal substrate. FIG. 8 illustrates that an anchoring structure can be formed in that context from plastic material 1.

FIG. 8 illustrates that in a method task x), plastic material 1 and substrate 2 are overmolded with a further plastic material 1′ in the form of an injection-molding material. In order to avoid deformation, during injection molding, of the anchoring structures embodied from plastic material 1, plastic material 1 can be completely solidified, for example cured, before injection molding in method task x), for example in a method task b1).

FIG. 8 further illustrates that in a method task c), portions of plastic material 1 which are adjacent to substrate 2 and to further plastic material 1′ applied as an injection-molding material are heated to a temperature at which the at least one thermally reversibly cleavable polymer of plastic material 1 becomes cleaved, and re-cools or is re-cooled while in contact with substrate 2 and with further plastic material 1′ applied as injection-molding material 1′. Chemical, in particular covalent, bonds are formed in this context at interfaces 3a between plastic material 1 and further plastic material 1′ applied as an injection-molding material, which bonds, in addition to the physical anchoring as a result of the shape of the anchoring structure, chemically anchor plastic material 1 and further plastic material 1′ applied as an injection-molding material. In addition, physical anchors are constituted at interfaces 3b between plastic material 1 and substrate 2 as a result of polymer units that have penetrated in cleaved form into pores in substrate 2 and have repolymerized both inside and outside the pores.

FIG. 9 is a schematic cross section through an embodiment of an intermediate layer 1, 1′ that can be used in the method according to the present invention, for example, as a self-supporting shaped plastic part, for example a film. FIG. 9 shows that intermediate layer 1, 1′ has a structured or discontinuous or interrupted layer 1 of isolated anchoring structures (intermediate layer segments) which are embodied from a plastic material 1 that encompasses at least one thermally reversibly cleavable polymer. FIG. 9 illustrates that anchoring structures 1 are partly overmolded with a further plastic material 1′, such that exposed or unovermolded surfaces of anchoring structures 1, and sub-segments of further plastic material 1′ that partly surround anchoring structures 1, together form a smooth outer surface of the shaped plastic part.

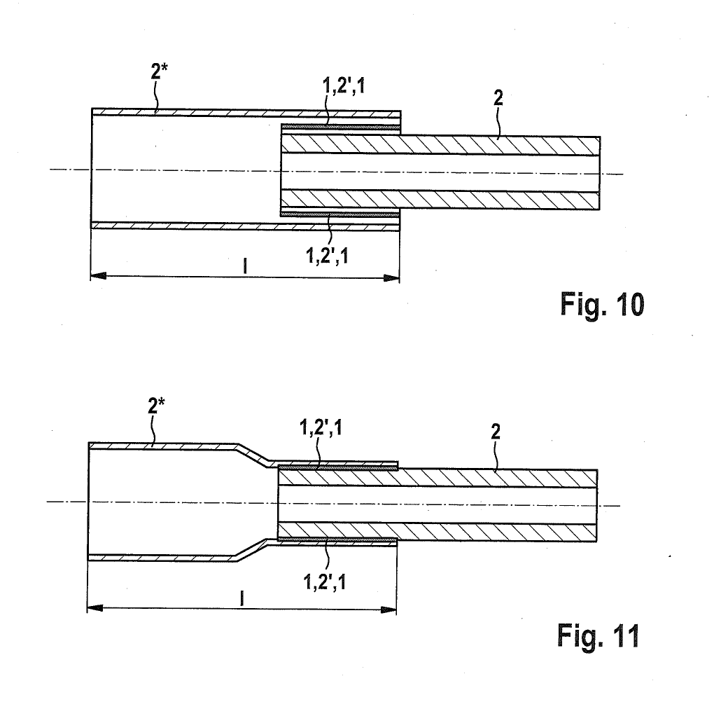

FIGS. 10 and 11 illustrate a further embodiment of the method and composite according to the present invention. Parts 2, 1, 2′, 1, 2* that are to be joined are two tubes 2, 2*, of which one tube 2 represents an inner tube and the other tube 2* represents an outer tube, which are joined to one another via a steel sheet 1, 2′, 1 disposed between them and equipped on both sides with plastic material 1.

FIG. 10 shows parts 2, 1, 2′, 1, 2* that are to be joined, before the method; FIG. 11 shows the resulting composite 2, 1, 2′, 1, 2* after the method.

Outer tube 2* can be, for example, a metal tube, e.g. an aluminum tube. Inner tube 2 can be a tube made of a different material, for example a metal tube, for example made of magnesium, or a plastic tube, for example made of carbon-fiber-reinforced plastic.

FIG. 10 furthermore shows that inner tube 2 is partly introduced, for example slid, into outer tube 2*.

FIG. 10 shows in particular that a steel sheet 2′, for example in the form of a sleeve, is disposed between inner tube 2 and outer tube 2*, said sheet being equipped on both sides with a plastic material 1 encompassing at least one thermally reversibly cleavable polymer. Steel sheet 2′ can, for example, be coated with plastic material 1, for example in the form of a paint.

FIG. 10 illustrates that inner tube 2 has an outer radius that is smaller than the inner radius of outer tube 2*. In particular, the radial spacing between the inner radius of outer tube 2* and the outer radius of inner tube 2 is greater than the radial thickness of steel sheet 2′ coated on both sides with plastic material 1. For example, outer tube 2* can have a diameter of approximately 30 mm and, for example, a wall thickness of 1.5 mm, and inner tube 2 can have a diameter of approximately 25 mm. Steel sheet 1, 2′, 1 that is coated on both sides can be a sleeve having an axial length of approximately 20 mm, for example in order to achieve a joining length of approximately 20 mm. The axial length of steel sheet 1, 2′, 1 can in principle, however, also be shorter or longer.

Length l of outer tube 2* can in this context be, for example, approximately 200 mm.

In the context of the embodiment shown in FIGS. 10 and 11, inner tube 2 and/or outer tube 2* can be regarded as a substrate. Coating 1 on both sides of steel sheet 2′ serves here on both sides as plastic material 1 encompassing at least one thermally reversibly cleavable polymer, and steel sheet 2′ itself can be regarded as an (intermediate) object. In other words, in the context of this embodiment, two substrates 2, 2*, namely inner tube 2 and outer tube 2*, are joined via an object 2′ coated on both sides with plastic material 1 encompassing at least one thermally reversibly cleavable polymer, namely via coated steel sheet 1, 2′, 1.

Advantageously, thanks to the coating 1 on both sides of steel sheet 2′ with plastic material 1 not only joining but also insulation is achieved, and galvanic corrosion, for example, can thereby be prevented.

In the context of the embodiment shown in FIGS. 10 and 11, the bringing of plastic material 1 into contact with the two substrates 2, 2*, namely with inner tube 2 and with outer tube 2*, is accomplished by deformation of one of tubes 2, 2*. In particular, in the embodiment shown in FIGS. 10 and 11, outer tube 2* is shrunk onto inner tube 2 and in that manner both outer tube 2* and inner tube 2 are brought into contact with plastic material 1 of steel sheet 2′, 1 that is coated on both sides. Alternatively thereto, the inner tube can also be expanded, for example inflated, and in this manner both the inner tube and the outer tube can be brought into contact with the plastic material of the steel sheet that is coated on both sides (not depicted). In both cases, the action of bringing into contact can be accomplished under pressure.

Deformation can be implemented using a variety of deformation methods. For example, inner tube 2 can be expanded or inflated by hydroforming. Deformation can also be accomplished, however, by a magnetic pulse method, for example magnetic shaping (also called electromagnetic pulse technology, EMPT), in which context, for example, the inner tube can be expanded or inflated and/or the outer tube can be shrunk. Deformation can also be accomplished mechanically, for example, by hammering, forging, etcetera, for example such that the outer tube can be forged onto the inner tube.

The method can be adapted in various ways with regard to different coefficients of thermal expansion of the various materials, in particular of the inner tube and/or outer tube and/or of the steel sheet.

On the one hand, adaptation can be accomplished by the fact that the inner tube exhibits greater thermal expansion than the outer tube; this can be achieved, for example, by suitable material selection and optionally dimensioning.

On the other hand, the method can be optimized with regard to different coefficients of thermal expansion by way of a suitable heating method.

In the context of the embodiment shown in FIGS. 10 and 11, for example the heating of plastic material 1 to a temperature at which the at least one thermally reversibly cleavable polymer of plastic material 1 becomes thermally cleaved can be accomplished by the fact that steel sheet 2′ is selectively heated, in particular without thereby heating outer tube 2*. This can be achieved, for example, by low-frequency heating, for example at approximately 50 Hz, for example by inductive low-frequency heating, or by the application of eddy current. Outer tube 2* can advantageously serve as a kind of cage that limits the expansion of steel sheet 2′. This can be advantageous in particular with material combinations in which the material of outer tube 2*, for example aluminum, has a higher coefficient of thermal expansion than steel sheet 2′ or inner tube 2.

The undeformed region, shown on the left in FIG. 11, of outer tube 2* can advantageously be used for joining to a further component. In this manner, for example, a vehicle frame, for example for a motor vehicle or bicycle, can be manufactured.

### EXAMPLES

### Example 1

A maleic acid homopolymer having a molecular weight of approximately 50,000 Dalton, which had been partly neutralized, in particularly at a proportion of approximately 30%, with dihexamethylenetriamine, was mixed with water and diethylene glycol dibutyl ether to yield a paint. A steel substrate was dipped into the paint and then cured for 10 min at a temperature of 220° C. The painted steel substrate was overmolded with polyamide 6,6. After one week the steel substrate was dried for twenty-four hours at a temperature of 150° C.

The overmolded, painted steel substrate was passed through an induction coil whose operating parameters had been preset so that the surface of the steel substrate (without overmolding and paint) could reach a temperature of 400° C. within approximately 10 ms. The overmolded, painted steel substrate was subjected in this manner to 800 thermal shock cycles.

After the thermal treatment the overmolded, painted steel substrate was cut axially into four portions.

The portions exhibited no visible delamination phenomena between the plastic and the metal. Although no anchoring structures had been provided, the plastic and the metal could not be detached from one another by hand.

### Example 2

A maleic acid homopolymer having a molecular weight of approximately 2,000 Dalton, which had been partly neutralized, in particularly at a proportion of approximately 25%, with monoethanolamine, was mixed with water to yield a paint. The paint was applied onto a steel substrate and cured for 1 min at a temperature of 250° C. The painted steel substrate was overmolded with polyamide 6,6. After one week the steel substrate was dried for twenty-four hours at a temperature of 150° C.

The overmolded, painted steel substrate was passed through an induction coil whose operating parameters had been preset so that the surface of the steel substrate (without overmolding and paint) could reach a temperature of 400° C. within approximately 10 ms. The overmolded, painted steel substrate was subjected in this manner to 800 thermal shock cycles.

After the thermal treatment the overmolded, painted steel substrate was cut axially into four portions.

The portions exhibited no visible delamination phenomena between the plastic and the metal. Although no anchoring structures had been provided, the plastic and the metal could not be detached from one another by hand.

What is claimed is:

1. A method for joining or adhering plastic to a substrate, the method comprising:
(a) furnishing a plastic material that encompasses at least one thermally reversibly cleavable polymer; and
(b) bringing the plastic material into contact with a substrate;
wherein a portion of the plastic material which is brought into contact with the substrate is heated to a temperature at which the at least one thermally reversibly cleavable polymer becomes thermally cleaved, and re-cooling or is re-cooled while in contact with the substrate.

2. The method of claim 1, wherein the portion of the plastic material which is brought into contact with the substrate is heated to a temperature >200° C.

3. The method of claim 1, wherein the portion of the plastic material which is brought into contact with the substrate is heated to a temperature ≧300° C.

4. The method of claim 1, wherein heating of the portion of the plastic material is accomplished by indirect or direct heating by: electromagnetic induction, eddy current, alternating current, and/or direct current, or electromagnetic radiation, including a laser, and/or microwaves and/or infrared radiation.

5. The method of claim 1, wherein the substrate includes one of a metal substrate and a plastic substrate.

6. The method of claim 1, wherein the plastic material is furnished in task a) in completely solidified form, or the plastic material is completely solidified in a task b1) accomplished prior to heating.

7. The method of claim 1, further comprising:
(x) applying a further plastic material onto the plastic material, including by injection molding.

8. The method of claim 1, wherein in task (b) the substrate is coated with the plastic material, wherein in task (b1) the plastic material is completely solidified, and wherein in task (x) the plastic material is over-injected and/or overmolded with the further plastic material.

9. The method of claim 1, further comprising:
(y) performing one of: (i) bringing the plastic material or the further plastic material into contact with an object, in particular with a metal object or plastic object, and (ii) bringing the plastic material into contact with a further object, in particular a metal object or plastic object, equipped with a further plastic material, so that the plastic material and the further plastic material contact one another.

10. The method of claim 1, wherein in task (a) the plastic material encompassing at least one thermally reversibly cleavable polymer is furnished in a manner applied onto an object.

11. The method of claim 10, wherein the object is equipped on at least two sides with the plastic material or with the plastic material and the further plastic material, and wherein in task (b) at least one plastic-material-equipped side of the object is brought into contact with the substrate, and at least one, in particular different, plastic-material-equipped side of the object is brought into contact with a further substrate.

12. The method of claim 1, wherein at least two tubes, in particular metal tubes, are joined to one another by the method, in which one of the tubes is introduced partly into the other tube, the overlapping region between the tubes is equipped at least partly with the plastic material and optionally with the further plastic material.

13. The method of claim 1, wherein in task (b) the action of bringing into contact is accomplished by a deformation method, in particular hydroforming, and/or by a magnetic pulse method and/or by a mechanical deformation method.

14. The method of claim 1, wherein for indirect heating of the plastic material and/or of the further plastic material and/or of the plastic substrate and/or of the plastic object, in particular only, a metallic part of the composite to be formed, in particular the object, and or the substrate and/or the further substrate is heated, in particular by low-frequency heating.

15. The method of claim 5, wherein the plastic substrate and/or the further plastic material and/or the plastic object encompass at least one thermally reversibly cleavable polymer.

16. The method of claim 7, wherein a portion of the plastic material which is brought into contact with the substrate, and a portion of the plastic material which is brought into contact with the further plastic material or with the object, is heated to a temperature at which the at least one thermally reversibly cleavable polymer of the plastic material and/or of the further plastic material and/or of the substrate and/or of the object becomes cleaved, and re-cooling while in contact with the substrate and with the further plastic material and/or object, or the plastic-material-equipped sides of the object which are brought into contact with the substrates is heated to a temperature at which the at least one thermally reversibly cleavable polymer of the plastic material and/or of the further plastic material becomes thermally cleaved, and re-cooling while in contact with the substrates.

17. The method of claim 1, wherein the at least one thermally reversibly cleavable polymer of the plastic material and/or of the further plastic material and/or of the plastic substrate and/or of the plastic object is selected from the group of amide- and/or imide- and/or carboxylic acid- and/or carboxylic acid anhydride-functionalized, in particular grafted and/or crosslinked polymers, in particular maleic acid polymers and/or polyolefins, maleinate resins, polyamides, polyimides, polyamide-imides, polyesters, epoxy resins, polyurethanes, aminoplasts, polyoxymethylene, polystyrene, polymethyl methacrylate, and combinations thereof.

18. A plastic/substrate composite, comprising:
a plastic material that encompasses at least one thermally reversibly cleavable polymer and which is in contact with and adhered to a substrate;
wherein a portion of the plastic material brought into contact with the substrate had been heated to a temperature at which the at least one thermally reversibly cleavable polymer becomes thermally cleaved, and re-cooling or is re-cooled while in contact with the substrate.

19. A maleic acid homopolymer, comprising:
a maleic acid homopolymer, in particular having an average molecular weight from ≧1000 Dalton to ≦60,000 Dalton, wherein the maleic acid homopolymer is partially amine-neutralized, wherein the maleic acid homopolymer is neutralized with a diamine or polyamine and/or with a difunctionalized or polyfunctionalized amine having an alcohol function, in particular the maleic acid homopolymer having a degree of neutralization in a range from ≧20 mol % to ≦40 mol %.

20. The method of claim 1, wherein at least two tubes, in particular metal tubes, are joined to one another by the method, in which one of the tubes is introduced partly into the other tube, the overlapping region between the tubes is equipped at least partly with the plastic material and optionally with the further plastic material, in particular,
the substrate and the further substrate are tubes and the object is a sheet coated on both sides with plastic material, the sheet coated on both sides with plastic material is disposed between the tubes, or
the substrate is a first tube and the object is a second tube, a side of the first tube facing toward the second tube is coated at least partly with the plastic material encompassing at least one thermally reversibly cleavable polymer,
in particular a side of the second tube facing toward the first tube is coated at least partly with the further plastic material encompassing at least one thermally reversibly cleavable polymer.

21. Use of a thermal cleavage of a thermally reversibly cleavable polymer, and/or of a reflow polymer chain member exchange between at least two thermally reversibly cleavable polymers, for adhesion, in particular for adhesive bonding, of metal and plastic or of metal and metal or of plastic and plastic.
